(19) United States
(12) Patent Application Publication
(10) Pub. No.: US 2006/0236405 A1
(43) Pub. Date: Oct. 19, 2006

(54) Portable terminal connectable to a content server

(75) Inventors: Toru Terauchi, Tokyo (JP); Jun Sato, Kanagawa-ken (JP); Keiko Watanabe, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/400,298

(22) Filed: Apr. 7, 2006

(30) Foreign Application Priority Data
Apr. 19, 2005 (JP) 2005-121727

(51) Int. Cl. H04L 9/32

(52) U.S. Cl. 726/27

(57) ABSTRACT

A portable terminal MA downloads a content from a content server and stores the content in a HDD of the portable terminal after encrypting the content key with a terminal bind information which is inherent to the portable terminal. After that, when the portable terminal backs up the downloaded content to a personal computer, the portable terminal decrypts the content key with the terminal bind information and encrypts the content with a telephone number information. On the contrary, when the portable terminal restores the backed up content from the personal computer, the portable terminal decrypts the encrypted content key with telephone number bind information and encrypts the content with the terminal bind or new terminal information.

### CROSS REFERENCE TO RELATED APPLICATION

This application is based upon the benefit of priority from the prior Japanese Application No. P2005-121727, filed Apr. 19, 2005, the entire contents of which are incorporated herein by reference.

### FIELD OF THE INVENTION

The present invention relates to a portable terminal, such as a cellular phone and a PDA (Personal Digital Assistants), which capable of backing up a content to an external storage and restoring the content from the external storage.

### DESCRIPTION OF THE BACKGROUND

In recent years, a distribution service for downloading rich content such as music content from a content server to a portable terminal has started to be widespread. In the portable terminal using this kind of service, downloaded content is temporarily stored in a memory. The content stored is read out from the memory and reproduced according to reproduction operation by a user.

In order to protect the content from failure of the portable terminal, it is proposed that the content stored in the portable terminal be backed up in an external storage such that a backup file of the content can be restored in the portable terminal from the external storage after repairing the portable terminal or after changing the portable terminal to another portable terminal. This is particularly necessary when a hard disk (HDD) is used as the memory.

For example, a method disclosed in JP-A-2004-48180 is known. In the method, a backup server is provided and, when the content server downloads content with usage rule to a terminal, the content server adds a network address of the backup server to the content and downloads the content. When the terminal backs up the content downloaded, the terminal transmits the content to the backup server on the basis of the network address. The backup server stores the content transmitted in association with a telephone number of the terminal at the transmission source. However, in this method, since the server dedicated for backup has to be provided, a content seller or a usage rule administrator is required to perform capital investment for the server.

A method of backing up content stored in a portable terminal using a separate personal computer owned by a user of the portable terminal is also conceivable. For example, content stored in a hard disk of the portable terminal is encrypted and the encrypted content is copied to the personal computer. When the content is erased because of trouble or the like of the hard disk, the encrypted content is restored in the hard disk from the personal computer. Consequently, the user can easily back up and restore the content acquired in the portable terminal using the personal computer owned by the user.

Some content is attached with information on rights (Usage Rule) representing details of conditions of use of the content. This kind of content is stored in a memory after being encrypted in order to prevent illegal copy. As a method of encryption, for example, there is known a method of encrypting content using a content key generated on the basis of random numbers and further encrypting the content key using a key that is generated on the basis of a telephone number of a portable terminal. This encryption system is called telephone number bind because the telephone number is used as the key. The telephone number bind can cope with change of the portable terminal to another portable terminal unless the telephone number is changed. Thus, the telephone number bind is suitable when the encrypted content is backed up and restored using the personal computer as described above.

However, in case that the telephone number bind is used as the encryption system, a deficiency described below occurs. When a portable terminal is changed to another portable terminal, a telephone number is written in a memory (ROM) of the new portable terminal and a telephone number stored in a memory (ROM) of the old portable terminal is erased. This makes it impossible to generate a telephone number bind key in the old portable terminal. As a result, in the old portable terminal, it is impossible to decrypt and reproduce encrypted content acquired and stored before the change of the portable terminal.

### SUMMARY OF THE INVENTION

The invention has been devised in view of the circumstances and it is an object of the invention to provide a portable terminal being capable of decrypting and reproducing an encrypted content acquired before the user identification information is erased, even if user identification information such as a telephone number is erased.

In order to attain the object, the invention may provide a portable terminal, which comprising: an interface which is connectable to a back up terminal; content acquiring means for acquiring a content from the content server; first encrypting means for encrypting the content using content encryption key and outputting a encrypted content; bind key generating means for generating a first bind key based upon the portable identification information and a second bind key based upon user identification information; second encrypting means for encrypting the content encryption key based upon the first bind key and outputting a first encrypted content key; a memory which stores the encrypted content and the first encrypted content key; conversion means for converting the first encrypted content key into a second encrypted content key if back up request is received, wherein the conversion means decrypts the first encrypted content key using the first bind key and generates the content key, and encrypts the generated content key using the second bind key and generates the second encrypted content key; and transfer means for transferring the encrypted content and the second encrypted content key to the back up terminal connected to the interface.

### BRIEF DESCRIPTION OF THE DRAWINGS

FIG. 1 is a block diagram showing a functional configuration of a portable terminal.

FIG. 2 is a diagram used for explanation of operations according to first embodiment.

FIG. 3 is a flowchart showing content downloading process and content storing process executed by a portable terminal.

FIG. 4 is a flowchart showing content backing up process executed by a portable terminal.

FIG. 5 is a flowchart showing content restoration process executed by a portable terminal.

FIG. 6 is a block diagram showing a functional configuration of a personal computer.

FIG. 7 is a diagram used for explanation of operations according to second embodiment.

FIG. 8 is a flowchart showing content backing up process executed by a back up terminal.

FIG. 9 is a flowchart showing content restoration process executed by a back up terminal.

FIG. 10 is a block diagram showing a functional configuration of a portable terminal.

FIG. 11 is a diagram used for explanation of operations according to third embodiment.

FIG. 12 is a flowchart showing content downloading process and content storing process executed by a portable terminal.

FIG. 13 is a flowchart showing content restoration process executed by a portable terminal.

FIG. 14 shows a file format for accommodating an encrypted content and additional information of the encrypted content.

FIG. 15 is a flowchart showing content backing up process executed by a back up terminal.

FIG. 16 is a diagram used for explanation of operations according to fourth embodiment.

FIG. 17 is a flowchart showing content restoration process executed by a back up terminal.

FIG. 18 is a diagram used for explanation of importing process according to from first embodiment to fourth embodiment.

FIG. 19 is a diagram used for explanation of importing process executed by a personal computer.

FIG. 20 is a block diagram showing a functional configuration of a portable terminal.

FIG. 21 is a diagram used for explanation of operations according to fifth embodiment.

FIG. 22 is a flowchart showing content downloading process and content storing process executed by a portable terminal.

FIG. 23 is a flowchart showing content reproducing process executed by a portable terminal.

FIG. 24 is a flowchart showing content restoration process executed by a portable terminal.

FIG. 25 is a diagram used for explanation of operations according to fifth embodiment.

FIG. 26 is a diagram used for explanation of importing process according to fifth embodiment.

FIG. 27 is a flowchart showing content backing up process executed by a back up terminal.

FIG. 28 is a diagram used for explanation of operations according to sixth embodiment.

FIG. 29 is a flowchart showing content restoration process executed by a back up terminal.

FIG. 30 is a diagram used for explanation of importing process according to sixth embodiment.

### DETAILED DESCRIPTION OF THE INVENTION

### First Embodiment

An information storing and reproducing system according to a first aspect of the invention encrypts, when acquired content is stored in a portable terminal, for example cellular phone, the content using a terminal bind key generated on the basis of a terminal specific identification number or the like of the portable terminal. When the encrypted content is backed up by a personal computer, the information storing and reproducing system transfers the encrypted content to the personal computer after converting, in the portable terminal, an encryption mode of the content to be backed up from terminal bind to telephone number bind based on a telephone number. When the encrypted content backed up in the personal computer is restored in a new portable terminal after portable terminal change, the information storing and reproducing system transfers the encrypted content to be restored from the personal computer to the portable terminal at the restoration destination and converts, in the portable terminal, the encryption mode from the telephone number bind to the terminal bind based on a terminal specific identification number of the portable terminal to store the encrypted content.

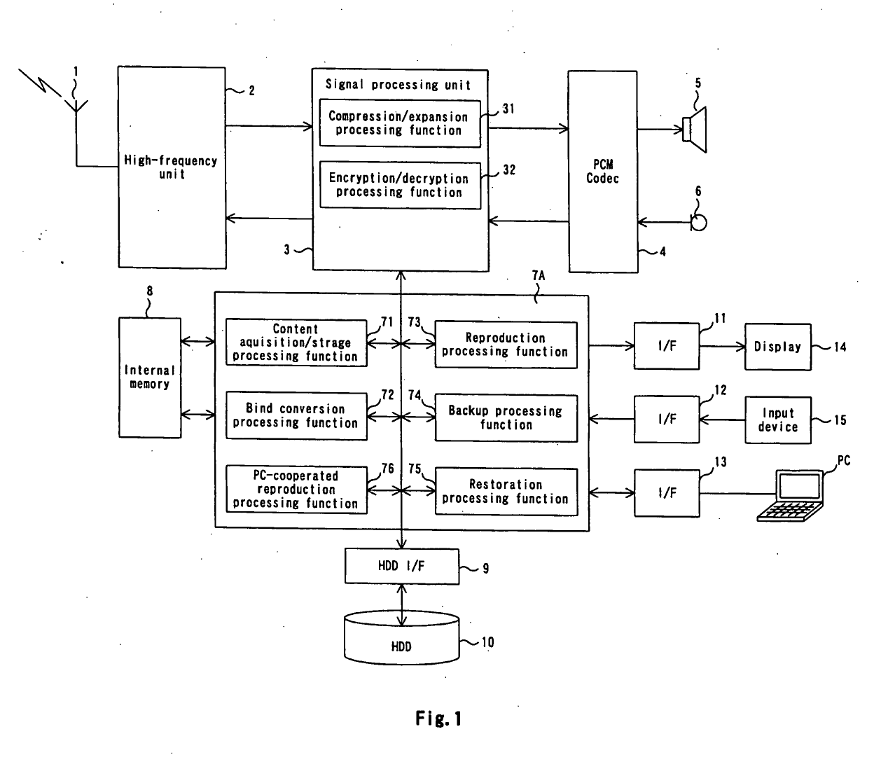

FIG. 1 is a block diagram showing a functional configuration of a portable terminal used as an information terminal in the information storing and reproducing system according to the first embodiment of the invention.

In FIG. 1, a radio signal transmitted from a base station (not shown) is received by an antenna 1 and, then, inputted to a high-frequency unit 2. In the high-frequency unit 2, down-convert of the radio signal received, quadrature demodulation processing for a down-converted intermediate frequency signal, despreading and combination processing for respective paths by a RAKE receiver, and the like are performed. Received packet data outputted from the RAKE receiver is inputted to a signal processing unit 3.

The signal processing unit 3 is constituted by, for example, a Digital Signal Processor (DSP) and has a compression/expansion processing function 31 and an encryption/decryption processing function 32. First, the compression/expansion processing function 31 separates the received packet data for each medium and, then, applies decryption processing to the data for each medium separated. For example, if audio data is included in the received packet data, the compression/expansion processing function 31 decrypts the audio data using a speech codec. If video data is included in the received packet data, the compression/expansion processing function 31 decrypts the video data using a video codec. If the received packet data is downloaded content, the content is expanded and, then, inputted to a control unit 7A.

A digital audio signal obtained by the decryption processing is subjected to PCM decoding by a PCM code processing unit (hereinafter called PCM codec) 4 and, then, amplified to be outputted from a speaker 5. A digital video signal decoded by the video codec is supplied to a display interface (a display I/F) 11 from the control unit 7A and displayed on a display 14.

On the other hand, a voice signal of a speaker inputted to a microphone 6 is amplified by a transmission amplifier (not shown) and, then, subjected to PCM coding by the PCM codec 4. Consequently, the voice signal is converted into a digital audio signal to be inputted to the signal processing unit 3. In the signal processing unit 3, the digital audio signal is subjected to compression coding by the compression/expansion processing function 31. A video signal outputted from a camera (not shown) and text data of a mail or the like created in the control unit 7A are also subjected to compression coding by the compression/expansion processing function 31. The compressed respective transmission data are multiplexed to be transmission packet data and inputted to the high-frequency unit 2.

In the high-frequency unit 2, spread spectrum processing, modulation processing using a digital modulation system such as a Quadrature Phase Shift Keying (QPSK) system, and up-convertint into a radio signal are performed. A radio transmission signal generated by the up-converting is subjected to power amplification and transmission filtering processing and, then, transmitted to the base station from the antenna 1.

The portable terminal has an internal memory 8 and a hard disk (HDD) 10 as storage media. The internal memory 8 consists of, for example, an EEPROM. A terminal specific identification number (a terminal ID) allocated to the portable terminal and a telephone number allocated to an owner (a user) of the portable terminal are stored in the internal memory 8. If the portable terminal has a slot for accommodating a memory card, the telephone number may be stored in this memory card. The HDD 10 is used mainly for storing acquired content.

The control unit 7A includes, for example, a microcomputer (CPU: Central Processing Unit). The control unit 7A has a content acquisition/storage processing function 71, a terminal to telephone number bind conversion processing function 72, a content reproduction processing function 73, a backup processing function 74, a restoration processing function 75, and a PC-cooperated reproduction processing function 76 as control functions according to the invention. All the functions 71 to 76 are realized by causing the microcomputer to execute programs.

The content acquisition/storage processing function 71 downloads content from a not-shown content server. The content is constituted by a content body and information on rights (Usage Rule) representing details of conditions of use of the content. The content acquisition/storage processing function 71 performs a series of processing for temporarily storing the downloaded content in the internal memory 8 and, then, encrypting and storing the content in the HDD 10. The encryption processing is performed by the encryption/decryption processing function 32 of the signal processing unit 3 on the basis of an encryption key. The encryption key is constituted by a content key generated on the basis of random numbers and a bind key for encrypting the content key. The bind key is generated on the basis of a terminal specific identification number of the terminal stored in the internal memory 8 and bind key generation information.

As the bind key generation information, for example, secret key identification information designating a secret key to be used among plural secret keys given from a carrier and content identification information generated for each piece of content are used. The secret key identification information is information for realizing revocation of a secret key. A secret key not revoked is designated by the secret key identification information. The content identification information is information for varying a bind key for each piece of content. For example, download time is used for EZ content and random numbers are used for EMD content and CD ripping content. If it is unnecessary to vary a bind key for each piece of content, the content identification information may be made unnecessary to use only the secret key identification information. The secret key identification information is not used either in some cases. As an encryption system, for example, Advanced Encryption Standard (AES) is used.

The content reproduction processing function 73 executes processing for decrypting and reproducing the encrypted content stored in the HDD 10. The content reproduction processing function 73 reads out the terminal specific identification number of the portable terminal stored in the internal memory 8 and generates a terminal bind key on the basis of the terminal specific identification number or the like and the bind key generation information added to the encrypted content. The content reproduction processing function 73 causes the encryption/decryption processing unit 32 of the signal processing unit 3 to decrypt the encrypted content key using the terminal bind key generated and decrypt the encrypted content stored in the HDD 10 using a content key generated by the decryption processing.

If the content decrypted is, for example, music content, the content reproduction processing function 73 supplies data of the music content to the PCM codec 4 and causes the speaker 5 to reinforce and output the music content. On the other hand, if the decrypted content is image content, the content reproduction processing function 73 supplies the image content to the display 14 from the control unit 7A via the display I/F 11 and causes the display 14 to display the image content. It is also possible to cause the signal processing unit 3 to perform the processing for generating the terminal bind key.

The backup processing function 74 executes processing for transferring the encrypted content stored in the HDD 10 to an external personal computer PC used as an information backup apparatus and causing the personal computer PC to back up the encrypted content. The restoration processing function 75 executes a series of processing for taking, according to change of the portable terminal, the encrypted content stored in the personal computer PC into a portable terminal after portable terminal change and restoring the encrypted content in the HDD 10. The data transfer to and from the personal computer PC is performed via an external interface (the external I/F) 13.

In the backup processing, the terminal to telephone number bind conversion processing function 72 converts an encryption mode of the encrypted content from terminal bind that uses the terminal bind key generated on the basis of the terminal specific identification number and the bind key generation information to telephone number bind that uses a telephone number bind key generated on the basis of the telephone number and the bind key generation information. In the restoration, the bind conversion processing function 72 converts the encryption mode of the encrypted content transferred from the personal computer PC from the telephone number bind that uses the telephone number bind key to the terminal bind that uses the terminal bind key generated on the basis of the terminal specific identification number of the terminal and the bind key generation information.

When the encrypted content backed up in the personal computer PC is decrypted and reproduced, the PC-cooperated reproduction processing function 76 establishes a secure session with the personal computer PC and transmits the telephone number bind key in response to a request of the personal computer PC.

Reference numeral 14 denotes a display such as a liquid crystal display and 15 denotes an input device such as a key pad. The display 14 displays received information, reproduced content, operation information of the portable terminal, and the like. Display data is supplied via the display interface (the display I/F) 11. The input device 15 is used for inputting operation information such as a command to the portable terminal by a user. The operation information is inputted to the control unit 7A via an input interface (the input I/F) 12.

Operations for storing and reproducing content using the portable terminal constituted as described above will be explained.

In an example explained below, content is acquired and stored in a portable terminal MA and the content is backed up in the personal computer PC and further restored in a portable terminal MB from the personal computer PC according to change of the portable terminal MA.

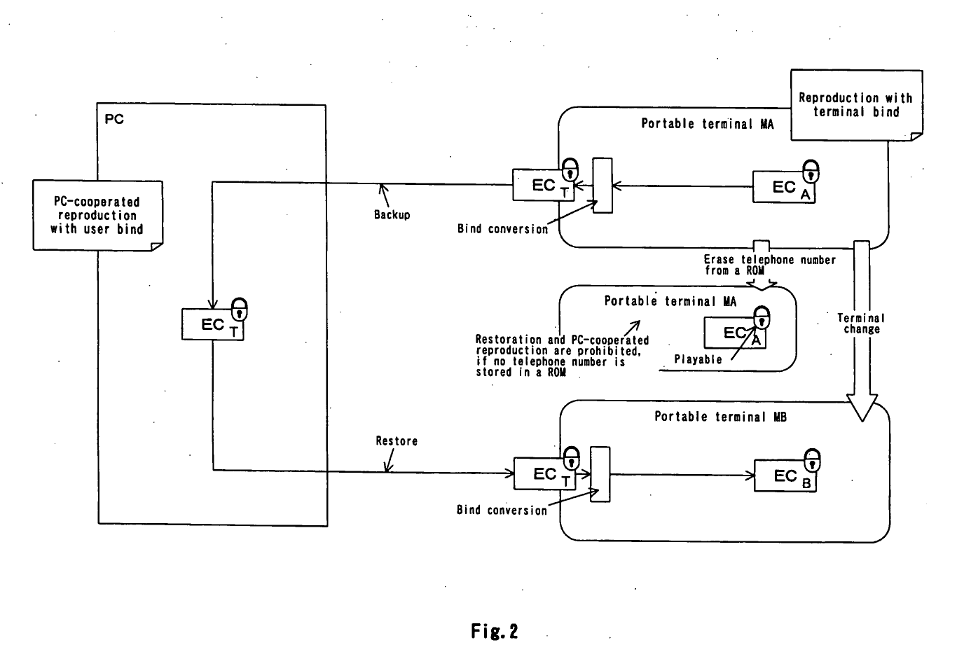

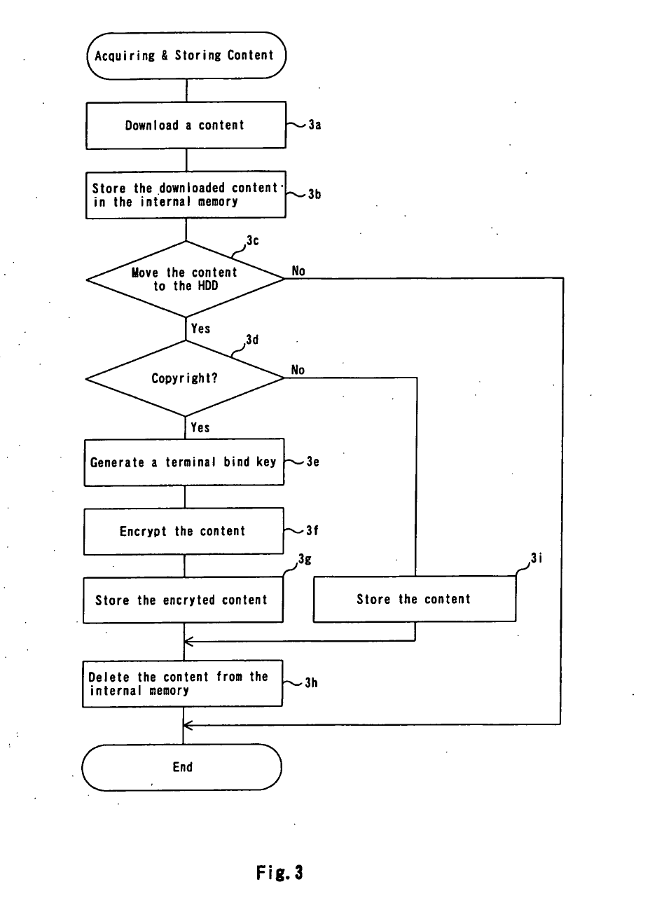

FIG. 2 is a system diagram used for explanation of the operations. FIGS. 3 to 5 are flowcharts showing control procedures and control details of the portable terminals MA and MB.

(1) Operations for Acquiring and Storing Content

The portable terminal MA downloads content from a content server under the control of the control unit 7A in step 3a as shown in FIG. 3. When the content is downloaded, the control unit 7A temporarily stores the downloaded content in the internal memory 8 in step 3b. The control unit 7A adds time of the download to the content as bind key generation information and stores the time.

It is assumed that, in a state in which the content is stored, necessity for moving the content to the HDD 10 has occurred because, for example, a free capacity of the internal memory 8 decreases to be less than a predetermined value. In this case, the control unit 7A shifts from step 3c to step 3d. In step 3d, the control unit 7A judges whether information on rights representing details of conditions of use is included in the content.

If the information on rights is included in the content, in step 3e, the control unit 7A generates a content key and a terminal bind key necessary for encrypting the content. The content key is generated on the basis of random numbers. The terminal bind key is generated on the basis of a terminal specific identification number of the portable terminal MA stored in the internal memory 8 and the bind key generation information (the download time) added to the content. When the generation of the respective keys ends, subsequently, in step 3f, the control unit 7A gives an execution instruction for encryption processing to the encryption/decryption processing unit 32. As a result, first, the encryption/decryption processing unit 32 encrypts the content to be encrypted using the content key. Subsequently, the encryption/decryption processing unit 32 encrypts the content key used for the encryption using the terminal bind key generated.

In step 3g, the control unit 7A stores the content encrypted in the HDD 10. In this case, the encrypted content key and the bind key generation information are added to the encrypted content. When the information on rights representing details of conditions of use is not included in the content to be moved, the control unit 7A shifts from step 3d to step 3i. In step 3i, the control unit 7A moves the content from the internal memory 8 to the HDD 10 without encrypting the content. After the movement processing, in step 3h, the control unit 7A deletes the content moved from the internal memory 8.

Consequently, the downloaded content is stored in the HDD 10 of the portable terminal MA in a state in which the content is encrypted by the terminal bind key for the portable terminal MA, that is, in a state in which the content is bound to the mobile terminal MA.

(2) Operation for Backing Up Content

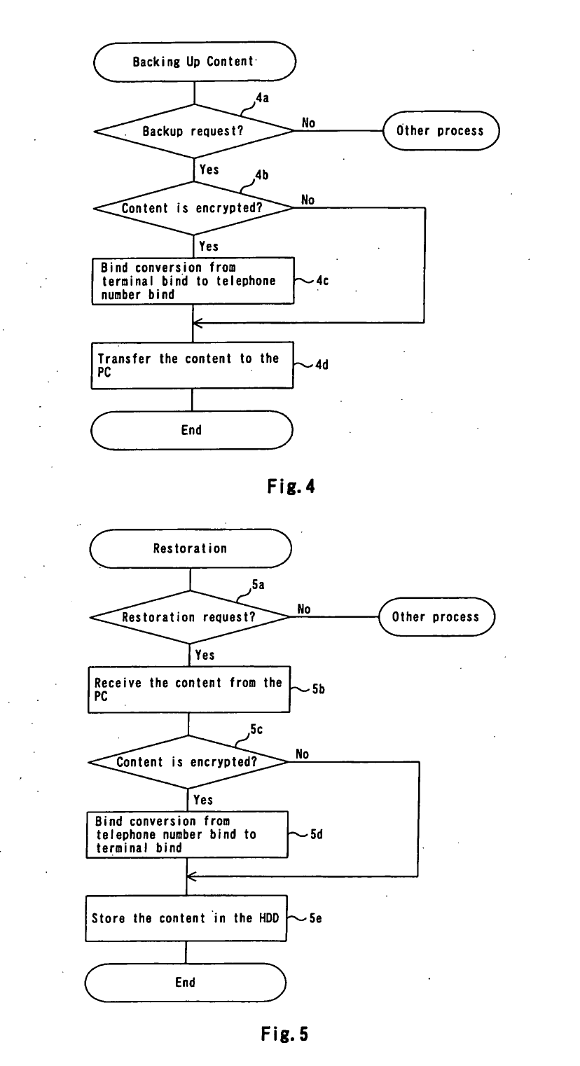

Since the HDD 10 is susceptible to a shock and easily breaks down, the content stored in the HDD 10 is backed up in the external personal computer PC. In this case, the personal computer PC is connected to the external I/F 13 via a USB cable or the like. The personal computer PC gives a backup request to the portable terminal MA. In response to the backup request, the portable terminal MA executes, under the control of the control unit 7A, backup processing for the content as described below. FIG. 4 is a flowchart showing control procedures and control details of the backup processing.

In step 4a, the control unit 7A detects the backup request from the personal computer PC. In step 4b, the control unit 7A judges whether the content to be backed up is encrypted content. As a result of the judgment, if the content to be backed up is encrypted content, in step 4c, the control unit 7A converts a bind mode of the encrypted content from terminal bind EC_{A} to telephone number bind EC_{T}. In the conversion processing, first, the control unit 7A generates a terminal bind key on the basis of the terminal specific identification number of the terminal MA and the bind key generation information and decrypts the encrypted content key using the terminal bind key. The control unit 7A generates a telephone number bind key on the basis of the telephone number stored in the internal memory 8 and the bind key generation information added to the encrypted content. The control unit 7A encrypts the decrypted content key using the telephone number bind key generated.

In step 4d, the control unit 7A reads out the encrypted content to be backed up from the HDD 10. The control unit 7A adds the content key encrypted by the telephone number bind key and the bind key generation information used for generating the telephone number bind key to the encrypted content. The control unit 7A transfers the encrypted content EC_{T} added with the encrypted content key and the bind key generation information to the personal computer PC via the external I/F 13. If the content to be backed up is not encrypted content, the control unit 7A shifts from step 4b to step 4d. In step 4d, the control unit 7A reads out corresponding content from the HDD 10 and transfers the content to the personal computer PC.

The personal computer PC receives the encrypted content EC_{T} added with the encrypted content key and the bind key generation information transferred from the portable terminal MA and stores the encrypted content EC_{T} received in a data memory in the personal computer PC.

Consequently, the content to be backed up is stored in the data memory of the personal computer PC in a state in which the content is subjected to the telephone number bind.

The outline of the backup processing operation described above is shown in FIG. 2.

(3) Operation for Restoring Backed-Up Content

When the portable terminal MA is changed to the portable terminal MB, the portable terminal MB is connected to the personal computer PC using a cable and, in this state, the encrypted content stored in the personal computer PC is restored in the portable terminal MB.

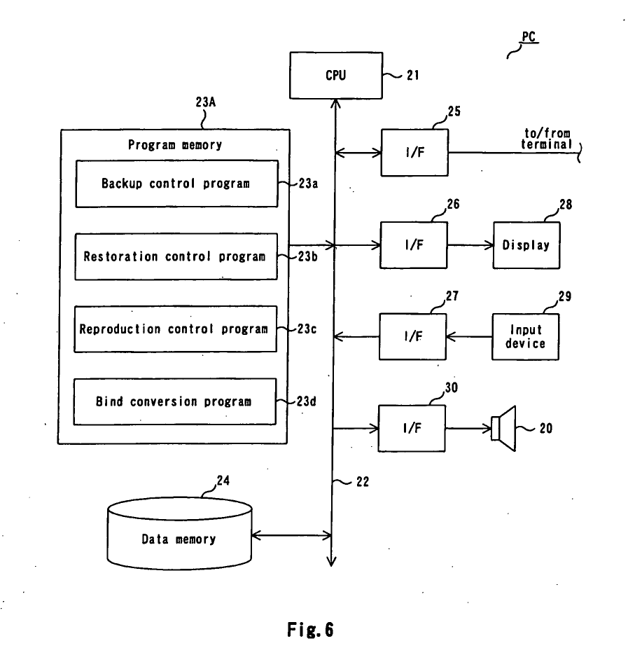

The portable terminal MB executes, under the control of the control unit 7A, restoration processing as described below. FIG. 5 is a flowchart showing control procedures and control details of the restoration processing. When a restoration request is received from the personal computer PC, the control unit 7A of the portable terminal MB shifts from step 5a to step 5b as shown in FIG. 5. Subsequently, the control unit 7A receives content transferred from the personal computer PC and temporarily stores the content received in the internal memory 8.

In step 5c, the control unit 7A of the portable terminal MB judges whether the received content is encrypted content. As a result of the judgment, if the received content is encrypted content, the control unit 7A shifts to step 5d. In step 5d, the control unit 7A converts a bind mode of the encrypted content from telephone number bind to terminal bind. In the conversion processing, first, the control unit 7A generates a telephone number bind key on the basis of the telephone number stored in the internal memory 8 and the bind key generation information added to the encrypted content and decrypts the encrypted content key using the telephone number bind key generated. The control unit 7A reads out the terminal specific identification number of the portable terminal MB from the internal memory 8 and generates a terminal bind key for the portable terminal MB on the basis of the terminal specific identification number, the bind key generation information added to the encrypted content, and the like. The control unit 7A encrypts the decrypted content key using the terminal bind key generated.

In step 5e, the control unit 7A of the portable terminal MB adds the terminal bind key for the portable terminal MB generated and the content key encrypted by the terminal bind key to the received encrypted content and stores encrypted content EC_{B} added with the content key in the HDD 10. If the content to be restored is not encrypted content, the control unit 7 directly stores the received content in the HDD 10.

Consequently, the content restored is stored in the HDD 10 of the portable terminal MB after portable terminal change in a state in which the content is encrypted again by the terminal bind key for the portable terminal MB, that is, a state in which the content is bound to the portable terminal MB. An outline of the restoration operation is shown in FIG. 2.

(4) Personal Computer-Cooperated Reproduction Operation

In a state in which the personal computer PC and the portable terminal MA are connected, it is possible to decrypt and reproduce the encrypted content not only in the portable terminal MA but also in the personal computer PC. The PC-cooperated reproduction operation is realized as described below.

The portable terminal MA at the backup source is connected to the personal computer PC using a cable. In this state, reproduction operation for the stored encrypted content is performed in the personal computer PC. Then, first, a secure session is established between the personal computer PC and the portable terminal MA. Subsequently, an acquisition request for a telephone number bind key is sent from the personal computer PC to the portable terminal MA together with the bind key generation information added to the encrypted content. In response to the request, the portable terminal MA generates a telephone number bind key on the basis of the bind key generation information sent and the telephone number stored in the internal memory 8 of the portable terminal MA. The portable terminal MA transfers the telephone number bind key generated to the personal computer PC via the secure session.

The personal computer PC decrypts the encrypted content key using the telephone number bind key transferred. The personal computer PC decrypts the encrypted content using the decrypted content key and reproduces and outputs the content decrypted.

As described above, in the first embodiment, in the portable terminal MA, the downloaded content is stored in a state in which the content is encrypted by the terminal bind key for the portable terminal MA. Thus, even if the telephone number stored in the internal memory 8 of the portable terminal MA is erased according to the portable terminal change, that is, even if the internal memory 8 becomes a blank ROM, it is possible to decrypt the encrypted content on the basis of the terminal specific identification number or the like stored in the internal memory 8. Therefore, the user can directly reproduce content acquired before the portable terminal change in the old portable terminal MA even after the portable terminal MA is changed to the portable terminal MB.

When the encrypted content is backed up in the personal computer PC, the encrypted content is converted from a state in which the encrypted content is subjected to the terminal bind to a state in which the encrypted content is subjected to the telephone number bind. Thus, even if the encrypted content backed up in the personal computer PC is restored in a new portable terminal MB after portable terminal has been changed because of failure and so on, unless a telephone number is changed according to the portable terminal change, it is possible to decrypt and reproduce the restored encrypted content on the basis of the telephone number.

In the restoration, the encrypted content to be restored is converted from a state in which the encrypted content is subjected to the telephone number bind to a state in which the encrypted content is subjected to the terminal bind to be bound to the portable terminal MB at the restoration destination. Thus, even if the portable terminal MB is changed to another portable terminal and the telephone number in the internal memory 8 is erased, that is, even if the internal memory 8 becomes a blank ROM, it is possible to decrypt and reproduce the restored encrypted content on the basis of the terminal specific identification number or the like of the portable terminal MB.

Moreover, the telephone number bind key is transferred from the portable terminal MA to the personal computer PC via the secure session and the encrypted content is decrypted and reproduced in the personal computer PC using the telephone number bind key transferred. Consequently, on condition that the identical portable terminal MA owned by an identical owner is connected to the personal computer PC, it is also possible to reproduce the encrypted content in the personal computer PC.

### Second Embodiment

An information storing and reproducing system according to a second embodiment of the invention is an information storing and reproducing system obtained by further improving the information storing and reproducing system in the first embodiment. When encrypted content stored in the portable terminal MA is backed up in the personal computer PC, processing for converting the encrypted content from a state in which the encrypted content is subjected to the terminal bind to a state in which the encrypted content is subjected to the telephone number bind is performed in the personal computer PC. When encrypted content stored in the personal computer PC is restored in the portable terminal MB, processing for converting the encrypted content from a state in which the encrypted content is subjected to the telephone number bind to a state in which the encrypted content is subjected to the terminal bind is performed in the personal computer PC.

FIG. 6 is a block diagram showing a functional configuration of the personal computer PC used as an information backup apparatus in the information storing and reproducing system according to the second embodiment of the invention.

The personal computer PC includes a Central Processing Unit (CPU) 21. A program memory 23A and a data memory 24 are connected to the CPU 21 via a bus 22. A communication interface (a communication I/F) 25, a display interface (a display I/F) 26, an input interface (an input I/F) 27, and a sound output interface (a sound output I/F) 30 are also connected to the CPU 21 via the bus 22.

The communication I/F 25 performs, under the control of the CPU 21, data transfer for content and the like between the personal computer PC and the portable terminal MA or MB via, for example, a USB cable. The display I/F 26 causes, under the control of the CPU 21, the display 28 to display data such as image content. As the display 28, for example, a liquid crystal display is used.

The input I/F 27 captures operation information inputted by a user in the input device 29 and communicates the operation information to the CPU 21. As the input device 29, for example, a keyboard or a mouse is used. The data memory 24 uses, for example, a RAM, an EEPROM, or a hard disk as a storage medium. The data memory 24 backs up encrypted content transferred from the portable terminal MA and a key for the encrypted content.

The sound output I/F 30 decrypts, under the control of the CPU 21, sound data such as music content and reinforces and outputs the sound data from the speaker 20.

As application programs related to the invention, a backup control program 23a, a restoration control program 23b, a content reproduction control program 23c, and a bind conversion program 23d are stored in the program memory 23A.

The backup control program 23a is a program for executing processing for backing up content between the personal computer PC and the portable terminal MA at the backup source. The backup control program 23a receives content to be backed up transferred from the portable terminal MA via the communication I/F 25 and stores the content in the data memory 24.

The restoration control program 23b is a program for executing processing for restoring content between the personal computer PC and the portable terminal MB at the restoration destination. The restoration control program 23b reads out content to be restored from the data memory 24 and transfers the content to be restored to the portable terminal MB via the communication I/F 25.

The content reproduction control program 23c is a program for executing processing for decrypting and reproducing the encrypted content backed up in cooperation with the portable terminal MA at the backup source. The content reproduction control program 23c establishes a secure session between the personal computer PC and the portable terminal MA and receives a telephone number bind key from the portable terminal MA via the secure session. The content reproduction control program 23c decrypts an encrypted content using the telephone number bind key received and decrypts the encrypted content using the content key decrypted.

In the process of the backup processing, the bind conversion program 23d converts an encryption mode of the encrypted content transferred from the portable terminal MA at the backup source from the terminal bind that uses a terminal bind key of the portable terminal MA to the telephone number bind that uses the telephone number bind key. In the process of the restoration processing, the bind conversion program 23d converts an encryption mode of the encrypted content transferred to the portable terminal MB at the restoration destination from the telephone number bind that uses a telephone number bind key to the terminal bind that uses a terminal bind key of the portable terminal MB. In the bind conversion, the telephone number bind key and the terminal bind key of the portable terminal MA are acquired from the portable terminal MA at the backup source via the secure session. The telephone number bind key and the terminal bind key of the portable terminal MB are acquired from the portable terminal MB at the restoration destination via the secure session.

Operations for storing and reproducing content using the personal computer PC constituted as described above will be explained.

As in the first embodiment, in an example explained in this embodiment, content is acquired and stored in the portable terminal MA and the content is backed up in the personal computer PC and restored in the portable terminal MB from the personal computer PC according to change of the portable terminal MA. However, operations for acquiring and storing content and an operation for reproducing the content in the portable terminal MA and an operation for reproducing content in the personal computer PC are identical with those in the first embodiment. Thus, an operation for backing up encrypted content and an operation for restoring the encrypted content will be explained in the second embodiment.

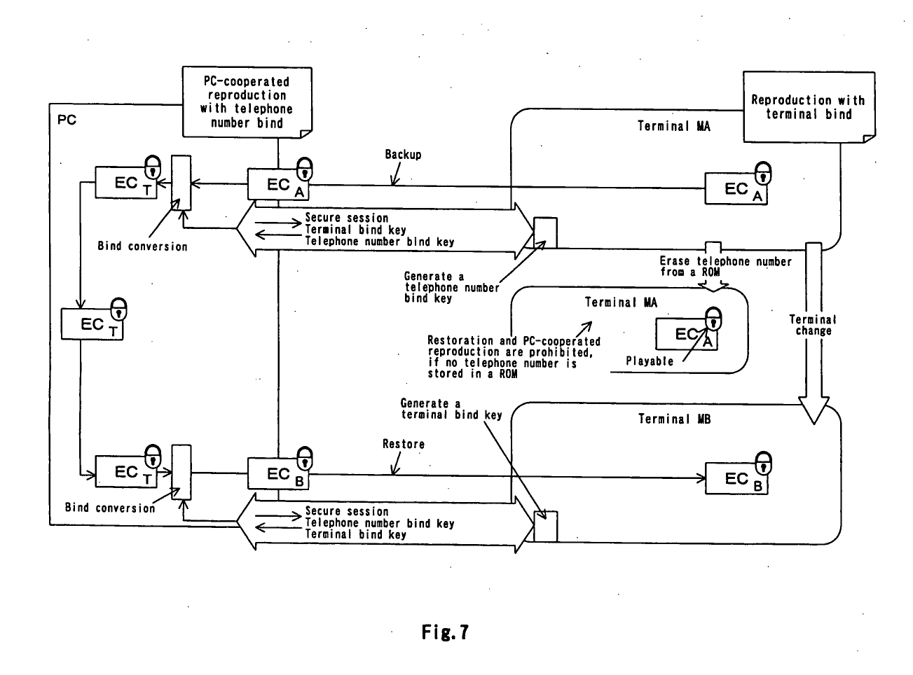

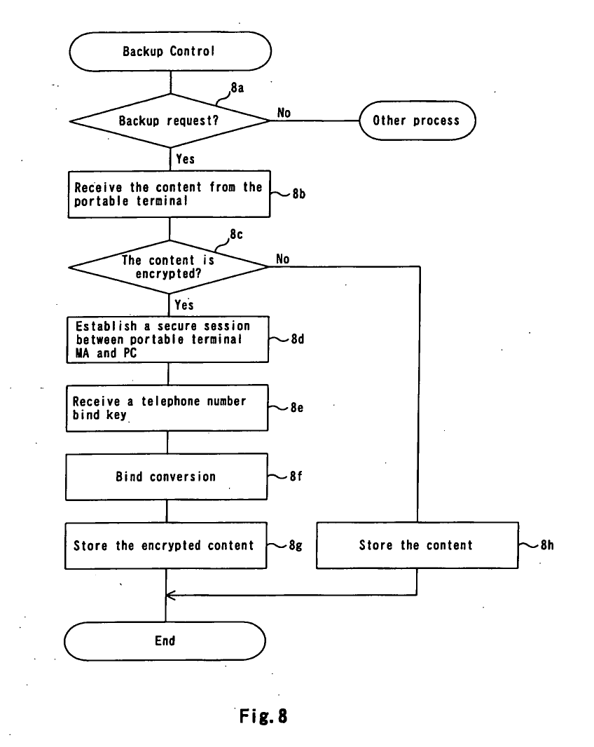

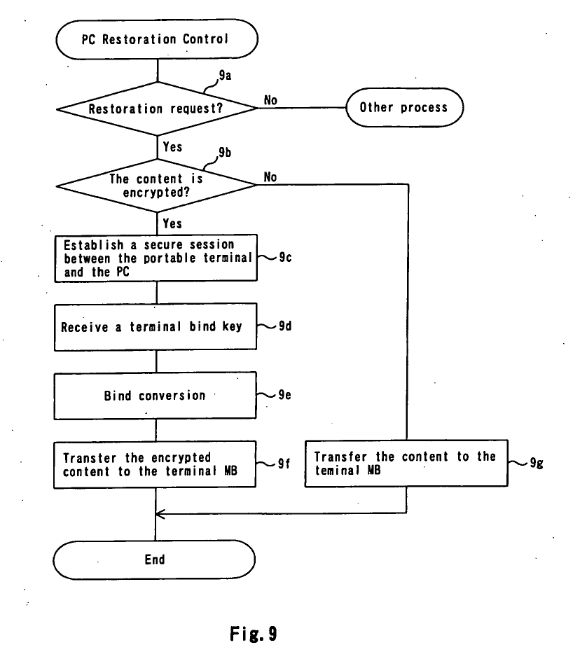

FIG. 7 is a system diagram used for explanation of the operations in this embodiment. FIGS. 8 and 9 are flowcharts showing control procedures and control details of the personal computer PC.

(1) Operation for Backing Up Content

When content is backed up, the portable terminal MA at the backup source is connected to the communication I/F 25 of the personal computer PC via a USB cable or the like. In this state, a backup request is inputted in the personal computer PC. The personal computer PC executes backup control as described below. FIG. 8 is a flowchart showing control procedures and control details of the backup control.

In step 8a, the CPU 21 of the personal computer PC detects the input of the backup request. In step 8b, the CPU 21 transmits a backup request to the portable terminal MA and receives content that is transferred from the portable terminal MA in response to the request. Subsequently, in step 8c, the CPU 21 judges whether the content received is encrypted content. As a result of the judgment, if the received content is encrypted content, the CPU 21 shifts to step 8d. In step 8d, the CPU 21 sets a secure session between the personal computer PC and the portable terminal MA at the backup source as shown in FIG. 7. In step 8e, the CPU 21 transfers bind key generation information added to the encrypted content to the portable terminal MA via the secure session together with a bind key acquisition request. In response to the bind key acquisition request, the portable terminal MA generates a telephone number bind key on the basis of the bind key generation information transferred and the telephone number stored in the internal memory 8 and transfers the telephone number bind key generated to the personal computer PC via the secure session.

Subsequently, in step 8f, the CPU 21 converts a bind mode of the encrypted content transferred from the portable terminal MA from the terminal bind EC_{A} to the telephone number bind EC_{T} using the telephone number bind key acquired. In step 8g, the CPU 21 stores the encrypted content subjected to the bind conversion in the data memory 24 together with the bind key generation information and a content key encrypted again by the telephone number bind key.

If the content to be backed up is not encrypted content, the CPU 21 shifts from step 8c to step 8h. In step 8h, the CPU 21 directly stores the content transferred from the portable terminal MA in the data memory 24.

Consequently, the content to be backed up is stored in the data memory of the personal computer PC in a state in which the content is converted into a content subjected to the telephone number bind.

(2) Operation for Restoring Backed-Up Content

When the portable terminal MA is changed to the portable terminal MB, the portable terminal MB is connected to the communication I/F 25 of the personal computer PC using a cable. In this state, restoration operation is performed in the personal computer PC. Then, the personal computer PC executes restoration control as described below. FIG. 9 is a flowchart showing control procedures and control details of the restoration control.

When the CPU 21 of the personal computer PC detects input of a restoration request in step 9a, the CPU 21 shifts to step 9b. In step 9b, the CPU 21 judges whether content to be restored is encrypted content. As a result of the judgment, if the content to be restored is encrypted content, the CPU 21 shifts to step 9c. In step 9c, the CPU 21 sets a secure session between the personal computer PC and the portable terminal MB at the restoration destination as shown in FIG. 7. In step 9d, the CPU 21 transfers bind key generation information added to the encrypted content to be restored to the portable terminal MB via the secure session together with a bind key acquisition request. In response to the acquisition request, the portable terminal MB generates a terminal bind key of the portable terminal MB on the basis of the bind key generation information transferred and the terminal specific identification information stored in the internal memory 8 and transfers the terminal bind key generated to the personal computer PC via the secure session.

Subsequently, in step 9e, the CPU 21 converts a bind mode of the encrypted content to be restored stored in the data memory 24 from the telephone number bind EC_{T} to the terminal bind EC_{B} using the terminal bind key acquired. In step 9f, the CPU 21 transfers the encrypted content subjected to the bind conversion to the portable terminal MB at the restoration destination together with the bind key generation information and a content key encrypted again by the terminal bind key.

When the content to be restored is not encrypted content, the CPU 21 shifts from step 9b to step 9g. In step 9g, the CPU 21 directly transfers the content read out from the data memory 24 to the portable terminal MB at the restoration destination.

Consequently, restored content is stored in the HDD 10 of the portable terminal MB after portable terminal change in a state in which the content is encrypted again by the terminal bind key for the portable terminal MB, that is, in a state in which the content is bound to the portable terminal MB.

As described above, according to the second embodiment, as in the first embodiment, downloaded content is stored in a state in which the content is encrypted by the terminal bind key for the portable terminal MA. Therefore, even if the telephone number stored in the internal memory 8 of the portable terminal MA is erased according to the portable terminal change, that is, even if the internal memory 8 becomes a blank ROM, it is possible to decrypt and reproduce the encrypted content on the basis of the terminal specific identification number or the like stored in the internal memory 8.

When the encrypted content is backed up by the personal computer PC, the encrypted content is converted from a state in which the encrypted content is subjected to the terminal bind to a state in which the encrypted content is subjected to telephone number bind. Therefore, even if the encrypted content backed up in the personal computer PC is restored in a new portable terminal MB after portable terminal has been changed, it is possible to decrypt and reproduce the restored encrypted content on the basis of the telephone number.

Moreover, in the restoration, the encrypted content to be restored is converted from a state in which the encrypted content is bound to a telephone number into a state in which the encrypted content is bound to the portable terminal MB at the restoration destination. Therefore, even if the portable terminal change is performed again and the telephone number is erased from the internal memory 8 of the portable terminal MB, that is, even if the internal memory 8 becomes a blank ROM, it is possible to decrypt and reproduce the restored encrypted content on the basis of the terminal specific identification number of the portable terminal MB.

Moreover, according to the second embodiment, the bind conversion at the time of backup and at the time of restoration is performed in the personal computer PC. Therefore, processing loads on the portable terminals MA and MB are reduced. In general, since performance of the CPU is higher in the personal computer PC than in the portable terminals MA and MB, as the information storing and reproducing system, processing efficiency is also improved by performing the bind conversion processing in the personal computer PC.

### Third Embodiment

An information storing and reproducing system according to a third embodiment of the invention encrypts, when acquired content is stored in a portable terminal, the content using both the terminal bind and the telephone number bind as encryption modes of the content. When the encrypted content is backed up by a personal computer and, then, restored in a portable terminal after portable terminal change, in the portable terminal, an encryption mode of the encrypted content is converted from terminal bind corresponding to a portable terminal before the portable terminal change into terminal bind corresponding to the portable terminal after portable terminal change.

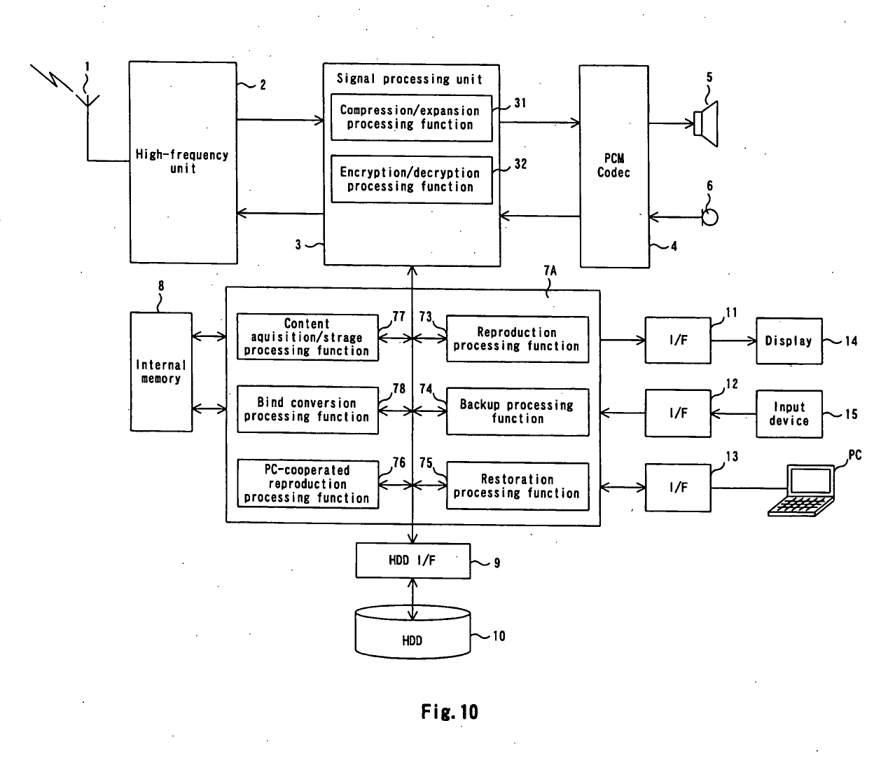

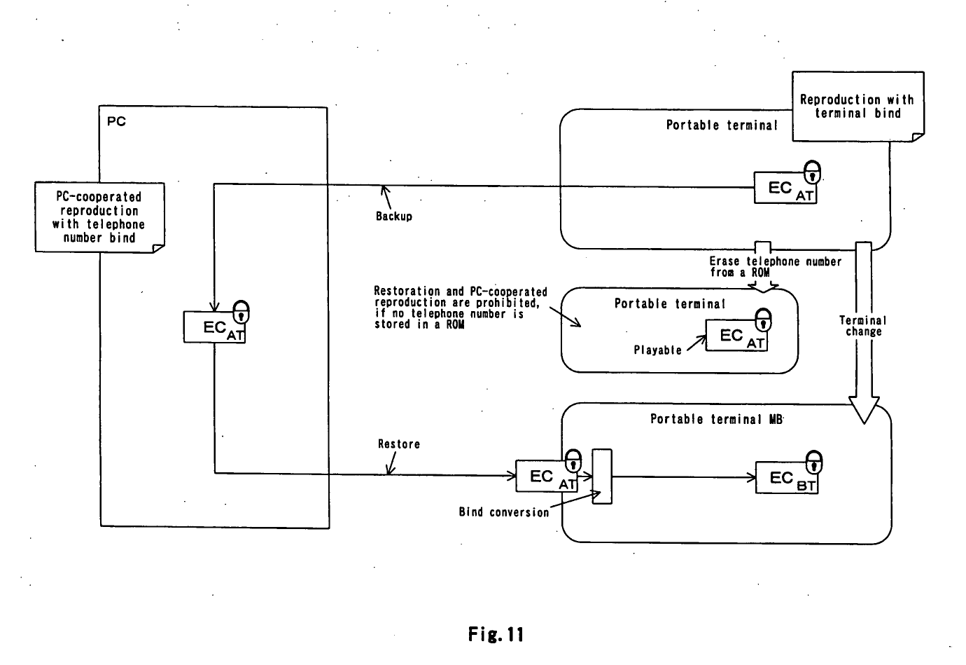

FIG. 10 is a block diagram showing a functional configuration of a portable terminal used as an information terminal in the information storing and reproducing system according to the third embodiment of the invention. In the figure, components identical with those in FIG. 1 are denoted by the identical reference numerals and signs. Detailed explanations of the components are omitted.

A control unit 7B has a content acquisition/storage processing function 77 and a bind conversion processing function 78 as functions peculiar to this embodiment.

The content acquisition/storage processing function 77 downloads content from a content server and encrypts the content downloaded using a content key. The content acquisition/storage processing function 77 further encrypts the content key using a terminal bind key and a telephone number bind key. The terminal bind key is generated on the basis of bind key generation information (e.g., download time of the content) and a terminal specific identification number of the portable terminal MA. The telephone number bind key is generated on the basis of the bind key generation information and a telephone number held by an owner of the portable terminal MA. The content acquisition/storage processing function 77 adds the content key encrypted by the terminal bind key and the content key encrypted by the telephone number bind key to the encrypted content together with the bind key generation information and stores the encrypted content in the HDD 10.

When encrypted content is restored, according to change of a portable terminal, in a portable terminal after portable terminal change from the personal computer PC, the bind conversion processing function 78 replaces a content key encrypted by a terminal bind key of the portable terminal before the portable terminal change added to the encrypted content with a content key encrypted by a terminal bind key of the portable terminal after the terminal change. Concerning an encryption mode of the encrypted content, the bind conversion processing function 78 converts a terminal bind from a terminal bind by the portable terminal before the portable terminal change to a terminal bind by the portable terminal after the portable terminal change while maintaining the telephone number bind.

Operations for storing and reproducing content using the portable terminal constituted as described above will be explained.

As in the first embodiment, in an example explained in this embodiment, content is acquired and stored in the portable terminal MA and the content is backed up in the personal computer PC and restored in the portable terminal MB from the personal computer PC according to change of the portable terminal MA.

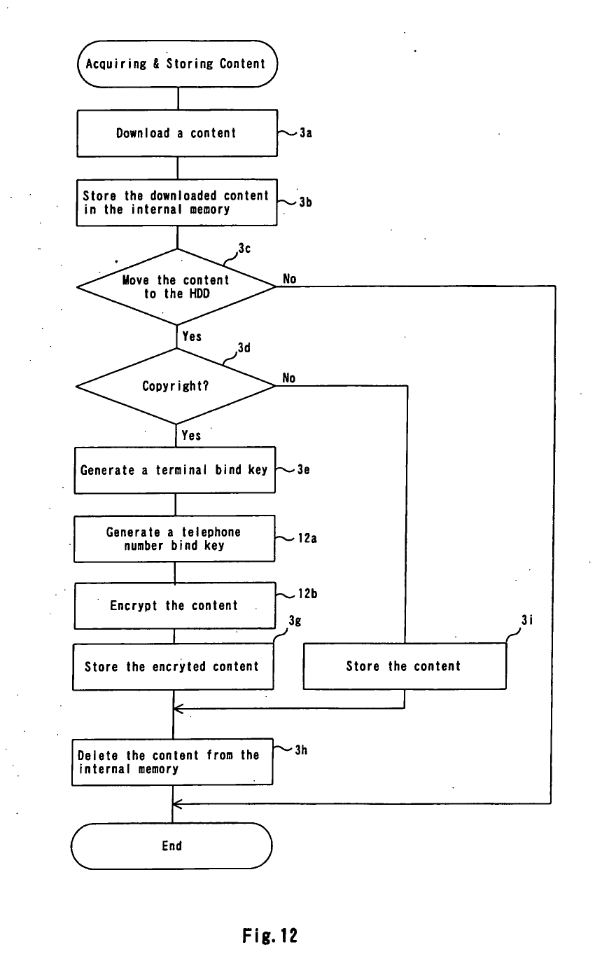

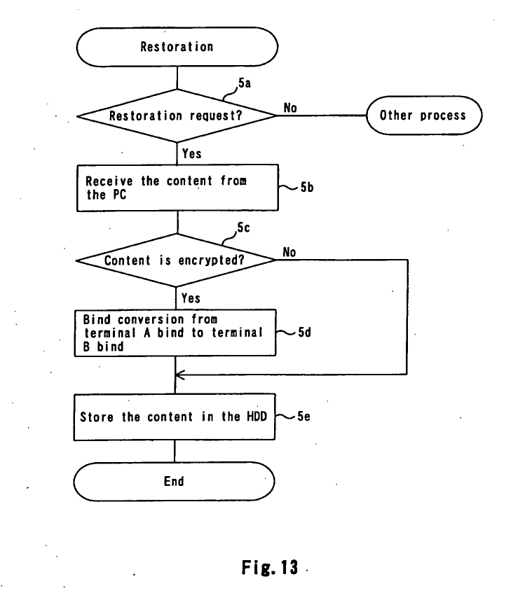

FIG. 11 is a system diagram used for explaining the operations. FIGS. 12 and 13 are flowcharts showing control procedures and control details of the portable terminals MA and MB. In FIGS. 12 and 13, steps identical with those in FIGS. 3 and 5 are denoted by the identical reference signs. Detailed explanations of the steps are omitted.

(1) Operations for Acquiring and Storing Content

When downloaded content is stored in the HDD 10, if copyright information is set in the content, the control unit 7B shifts to step 3e. In step 3e, the control unit 7B generates a content key and a terminal bind key. In step 12a, the control unit 7B generates a telephone number bind key. The content key is generated on the basis of random numbers. The terminal bind key is generated on the basis of the terminal specific identification number of the portable terminal MA stored in the internal memory 8 and bind key generation information (e.g., download time of the content). The telephone number bind key is generated on the basis of a telephone number of the portable terminal MA stored in the internal memory 8 and the bind key generation information.

When the generation of the respective bind keys ends, subsequently, in step 12b, the control unit 7B gives an execution instruction for encryption processing to the encryption/decryption processing unit 32. As a result, first, the encryption/decryption processing unit 32 applies encryption to the content to be encrypted using the content key. Subsequently, the control unit 7B encrypts the content key used for the encryption of the content using the terminal bind key and the telephone number bind key generated to generate first and second encrypted content keys.

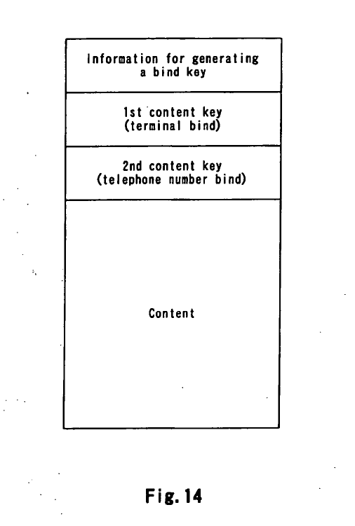

Subsequently, in step 3g, the control unit 7B stores the encrypted content in the HDD 10. In this case, the first and the second encrypted content keys and the bind key generation information (download time of the content, etc.) used for the encryption are added to the encrypted content. FIG. 14 is a diagram showing a file format for accommodating the encrypted content and additional information of the encrypted content.

Consequently, the downloaded content is stored in the HDD 10 of the portable terminal MA in a state in which the content is encrypted by the terminal bind key and the telephone number bind key for the portable terminal MA. The content stored in the portable terminal MA is stored in a state in which the content is subjected to terminal bind and telephone number bind as indicated by EC_{AT} in FIG. 11.

(2) Operation for Backing Up Content

As backup for the content stored in the HDD 10 of the portable terminal MA, the portable terminal MA is connected to the personal computer PC and, in this state, encrypted content to be backed up and additional information of the encrypted content are read out from the HDD 10 of the portable terminal MA and transferred to the personal computer PC. The encrypted content and the additional information of the encrypted content transferred are directly stored in a data memory.

(3) Operation for Restoring Backed-Up Content

An operation for restoring encrypted content at the time when the portable terminal MA is changed to the portable terminal MB is performed as described below. FIG. 13 is a flowchart showing control procedures and control details of the control unit 7B in the portable terminal MB at the restoration destination.

When a restoration request is received from the personal computer PC, as shown in FIG. 13, the control unit 7B of the portable terminal MB shifts from step 5a to step 5b. In step 5b, the control unit 7B receives content transferred from the personal computer PC and temporarily stores the content received in the internal memory 8.

Subsequently, in step 5c, the control unit 7B of the portable terminal MB judges whether the content received is encrypted content. As a result of the judgment, if the received content is encrypted content, the control unit 7B shifts to step 13a. In step 13a, the control unit 7B converts a bind mode of the encrypted content.

Processing for the conversion is performed as follows. The control unit 7B reads out a terminal specific identification number of the portable terminal MB from the internal memory 8 and generates a terminal bind key for the portable terminal MB on the basis of the terminal specific identification number and bind key generation information added to the encrypted content. Subsequently, the control unit 7B encrypts the decrypted content key using the terminal bind key for the portable terminal MB generated. The control unit 7B replaces the content key encrypted by the terminal bind key for the portable terminal MB with the content key encrypted by the terminal bind key for the portable terminal MA added to the encrypted content transferred.

In step 5e, the control unit 7B of the portable terminal MB stores the transferred encrypted content in the HDD 10 together with the bind key generation information, a content key encrypted by the telephone number bind key (a second encrypted content key), and a content key encrypted by the terminal bind key (a third encrypted content key).

Consequently, restored content is stored in the HDD 10 of the portable terminal MB after portable terminal change in a state in which the content is encrypted by the terminal bind key for the portable terminal MB while maintaining the telephone number bind, that is, in a state in which the content is bound by both the telephone number and the portable terminal MB. An outline of the restoration operation is shown in FIG. 11.

As described above, according to the third embodiment, in the portable terminal MA, content is stored in a state in which the content is subjected to the terminal bind and further subjected to the telephone number bind. Therefore, even if the telephone number stored in the internal memory 8 of the portable terminal MA is erased according to portable terminal change, that is, even if the internal memory 8 becomes a blank ROM, it is possible to decrypt the encrypted content on the basis of the terminal specific identification number or the like stored in the internal memory 8.

Since the content is subjected to the terminal bind and subjected to the telephone number bind, bind conversion from the terminal bind to the telephone number bind is unnecessary at the time of backup of the content. Moreover, when encrypted content is restored in the portable terminal MB after portable terminal change from the personal computer PC, an encryption mode of the encrypted content is converted from bind by the terminal bind key of the portable terminal MA before the portable terminal change to bind by the terminal bind key of the portable terminal MB after portable terminal change. In other words, bind conversion between the terminals is performed. Therefore, even if the telephone number stored in the internal memory 8 of the portable terminal MB is erased by performing the portable terminal change again, it is possible to directly reproduce content acquired before the portable terminal change in the portable terminal MB.

### Fourth Embodiment

An information storing and reproducing system according to a fourth embodiment of the invention is an information storing and reproducing system obtained by further improving the information storing and reproducing system in the third embodiment. When encrypted content stored in the personal computer PC is restored in the portable terminal MB, the personal computer PC performs processing for converting terminal bind for the encrypted content from terminal bind corresponding to the portable terminal MA before portable terminal change to terminal bind corresponding to the portable terminal MB after portable terminal change.

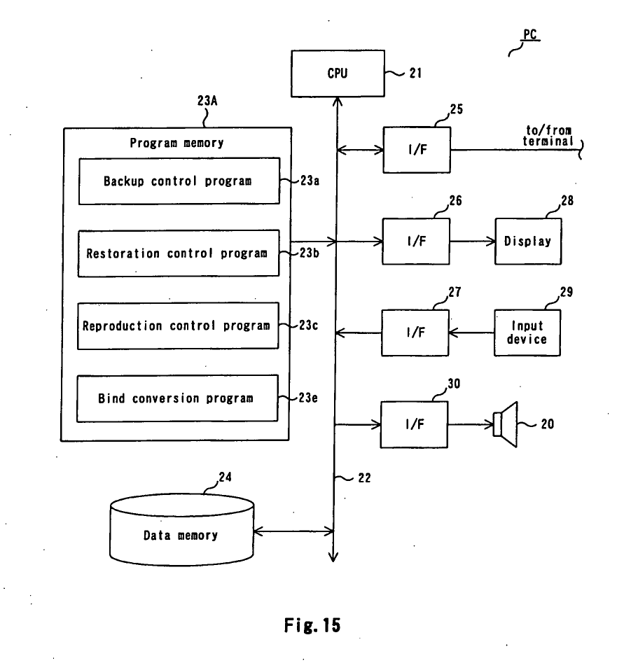

FIG. 15 is a block diagram showing a functional constitution of the personal computer PC used as an information backup apparatus in the information storing and reproducing system according to the fourth embodiment of the invention. In the figure, components identical with those in FIG. 6 are denoted by the identical reference numerals and signs. Detailed explanations of the components are omitted.

As a control program peculiar to this embodiment, a bind conversion program 23e is stored in the program memory 23B. When encrypted content stored in the personal computer PC is restored in the portable terminal MB after portable terminal change, the bind conversion program 23e performs processing for converting terminal bind for the encrypted content from terminal bind corresponding to the portable terminal MA before the portable terminal change to terminal bind corresponding to the portable terminal MB after portable terminal change. For processing for the bind conversion, a secure session is established between the personal computer PC and the portable terminal MB after portable terminal change. A terminal bind key of the portable terminal MB after portable terminal change is acquired from the portable terminal MB via the secure session. The terminal bind key is generated on the basis of a terminal specific identification number stored in the internal memory 8 of the portable terminal MB and bind key generation information added to the encrypted content.

An operation for restoring content using the personal computer PC constituted as described above will be explained.

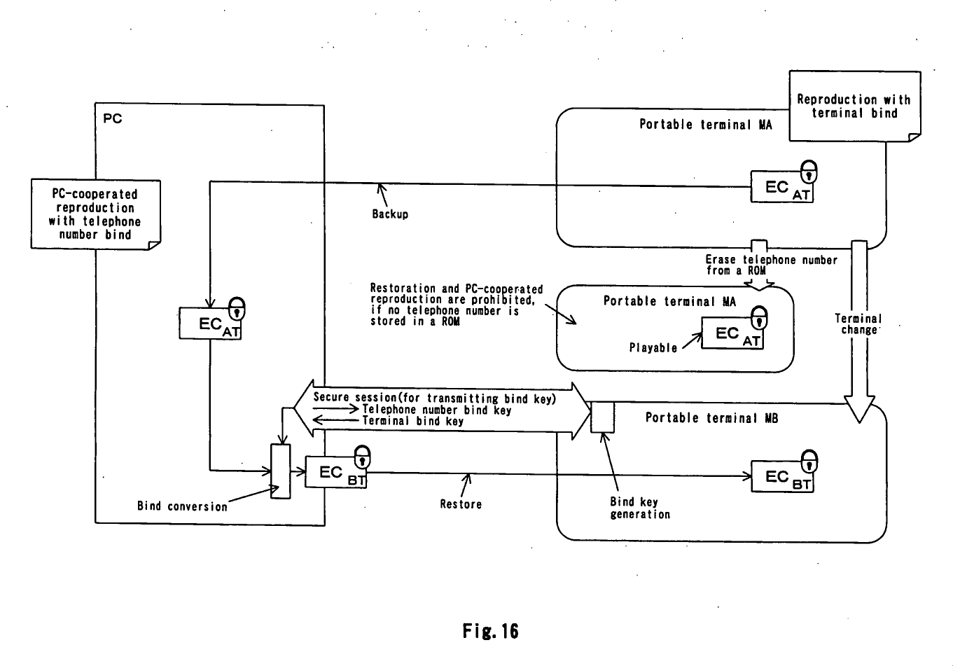

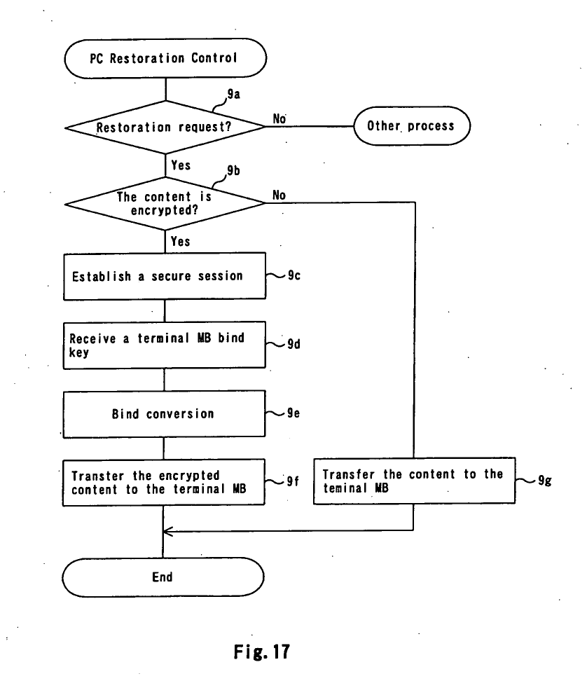

FIG. 16 is a system diagram used for explanation of this operation. FIG. 17 is a flowchart showing procedures and details of restoration control in the personal computer PC. In FIG. 17, steps identical with those in FIG. 9 are denoted by the identical reference signs. Detailed explanations of the steps are omitted.

When the CPU 21 of the personal computer PC detects input of a restoration request in step 9a, the CPU 21 shifts to step 9b. In step 9b, the CPU 21 judges whether content to be restored is encrypted content. As a result of the judgment, if the content is encrypted content, the CPU 21 shifts to step 9c. In step 9c, the CPU 21 establishes a secure session between the personal computer PC and the portable terminal MB at the restoration destination as shown in FIG. 16. In step 9d, the CPU 21 transfers bind key generation information added to the encrypted content to be restored to the portable terminal MB via the secure session together with a bind key acquisition request. In response to the acquisition request, the portable terminal MB generates a terminal bind key on the basis of the bind key generation information transferred together with the acquisition request and a terminal specific identification number stored in the internal memory 8 of the portable terminal MB and transfers the terminal bind key generated to the personal computer PC via the secure session.

Subsequently, in step 17a, the CPU 21 converts a bind mode of the encrypted content to be restored stored in the data memory 24 from the terminal bind EC_{AT} for the portable terminal MA to the terminal bind EC_{BT} for the portable terminal MB on the basis of the terminal bind key of the portable terminal MB acquired. In step 9f, the CPU 21 transfers the encrypted content, the bind mode of which is converted from the terminal bind EC_{AT} to the terminal bind EC_{BT}, to the portable terminal MB at the restoration destination together with additional information of the encrypted content.

Consequently, restored content is stored in the HDD 10 of the portable terminal MB after portable terminal change in a state in which the content is encrypted by the terminal bind key for the portable terminal MB while maintaining the telephone number bind.

As described above, according to the fourth embodiment, an advantage described below is realized in addition to the various advantages described in the third embodiment. When encrypted content is restored in the portable terminal MB after portable terminal change from the personal computer PC, in the personal computer PC, an encryption mode of the encrypted content is converted from an encryption mode by the terminal bind key of the portable terminal MA before the portable terminal change to an encryption mode by the terminal bind key of the portable terminal MB after portable terminal change. Therefore, since bind conversion processing in the portable terminal MB is unnecessary, it is possible to reduce processing burdens on the portable terminal MB.

### Fifth Embodiment

An information storing and reproducing system according to a fifth embodiment of the invention adds, when acquired content is encrypted and stored in the portable terminal MA, telephone number generation information, which is obtained by encrypting the content according to telephone number bind and further encrypting the telephone number using a terminal specific identification number of the portable terminal MA, to the content. When the encrypted content is restored in the portable terminal MB after portable terminal change from the personal computer PC according to portable terminal change, in the portable terminal MB, the telephone number generation information added to the encrypted content is replaced with information obtained by encrypting the telephone number with a terminal specific identification number of the portable terminal MB.

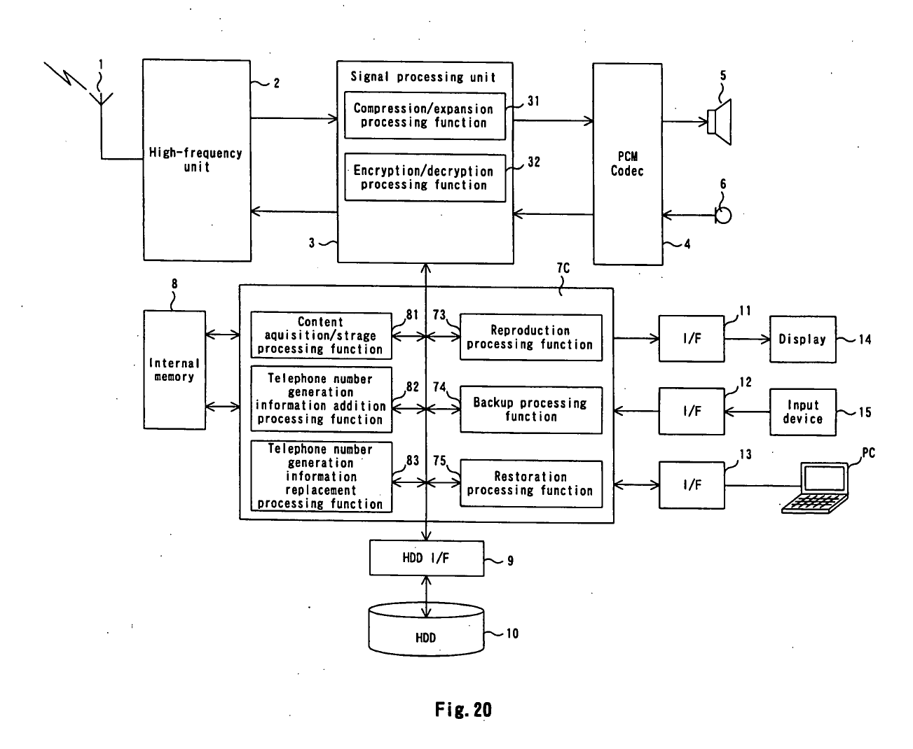

FIG. 20 is a block diagram showing a functional configuration of a portable terminal used as an information terminal in the information storing and reproducing system according to the fifth embodiment of the invention. In the figure, components identical with those in FIG. 1 are denoted by the identical reference numerals and signs. Detailed explanations of the components are omitted.

A control unit 7C has a content acquisition/storage processing function 81, a telephone number generation information addition processing function 82, and a telephone number generation information replacement processing function 83 as functions peculiar to this embodiment.

The content acquisition/storage processing function 81 downloads content from a content server and encrypts the content downloaded using a content key. The content acquisition/storage processing function 81 further encrypts the content key using a telephone number bind key that is generated on the basis of bind key generation information (download time of the content, etc.) and a telephone number Tell. The content acquisition/storage processing function 81 adds the bind key generation information used for generation of the telephone number bind key and the content key encrypted to a header of the encrypted content and stores the bind key generation information and the encrypted content key in the HDD 10.

When the encrypted content is stored in the HDD 10, the telephone number generation information addition processing function 82 encrypts the telephone number Tell using a terminal specific identification number ID_{A} of the portable terminal MA to generate telephone number generation information E-Tell. The telephone number generation information addition processing function 82 adds the telephone number generation information E-Tell generated to the encrypted content.

When the encrypted content added with the telephone number generation information E-Tell is restored in the portable terminal MB after portable terminal change from the personal computer PC, the telephone number generation information replacement processing function 83 encrypts the telephone number Tell using a terminal specific identification number ID_{B} of the portable terminal MB to generate telephone number generation information E-Tell again and replaces the telephone number generation information E-Tell added to the encrypted content restored with the telephone number generation information E-Tell.

Operations for storing and reproducing content using the portable terminal constituted as described above will be explained.

As in the first embodiment, in an example explained in this embodiment, content is acquired and stored in the portable terminal MA, the content is backed up in the personal computer PC and the content is restored in the portable terminal MB from the personal computer PC according to portable terminal change of the portable terminal MA.

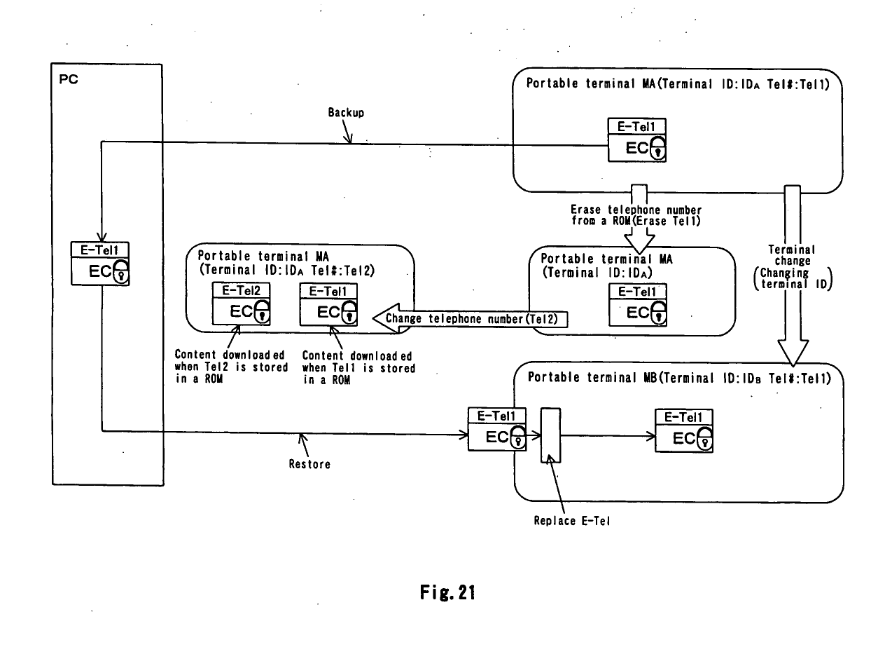

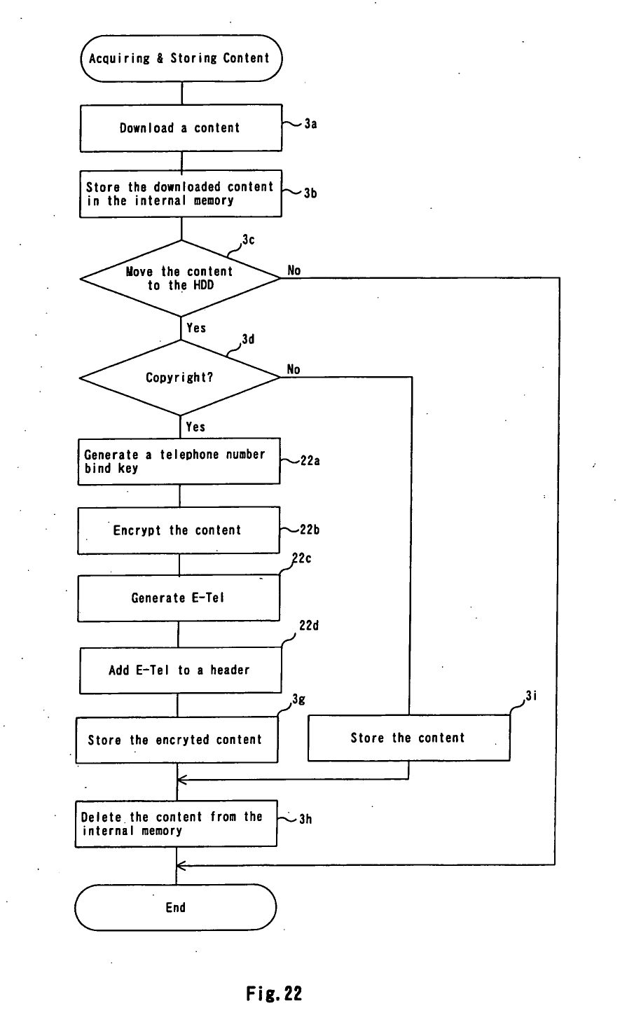

FIG. 21 is a system diagram used for explanation of the operations. FIGS. 22 to 24 are flowcharts showing control procedures and control details of the portable terminals MA and MB. In FIGS. 22 to 24, steps identical with those in FIGS. 3 and 5 are denoted by the identical reference signs. Detailed explanations of the steps are omitted.

(1) Operations for Acquiring and Storing Content

In the portable terminal MA, when downloaded content is stored in the HDD 10, if copyright is set in the content, the control unit 7C shifts to step 22a. In step 22a, the control unit 7C generates a content key and a telephone number bind key. The content key is generated on the basis of random numbers. The telephone number bind key is generated on the basis of telephone number Tell of the portable terminal MA stored in the internal memory 8 and bind key generation information (download time of the content, etc.).

When the generation of the telephone number bind key ends, subsequently, in step 22b, the control unit 7C gives an execution instruction for encryption processing to the encryption/decryption processing unit 32. As a result, first, the encryption/decryption processing unit 32 applies encryption to the content to be encrypted using the content key. Subsequently, the control unit 7C encrypts the content key used for the encryption of the content using the telephone number bind key generated to generate an encrypted content key.

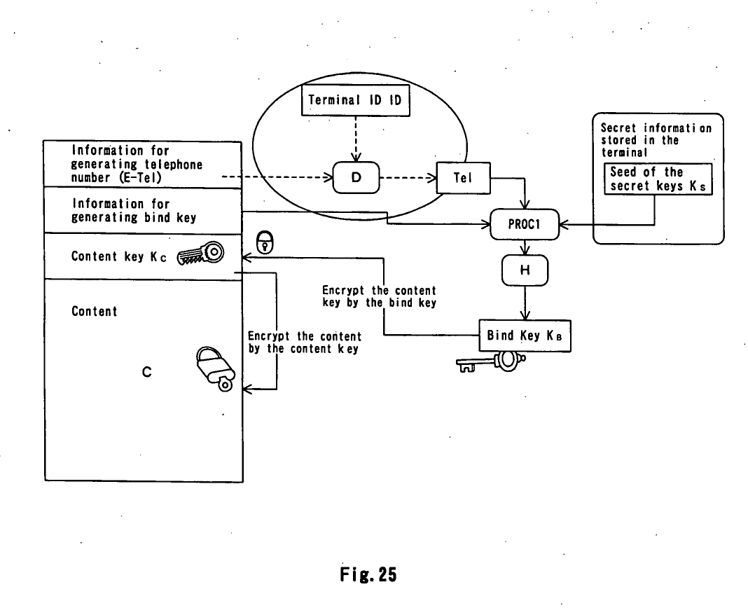

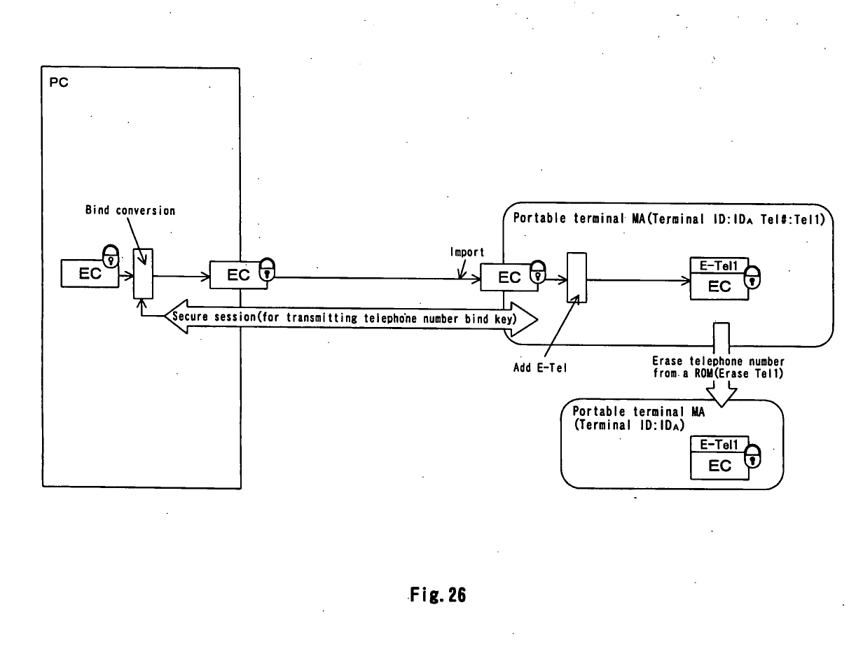

Subsequently, in step 22c, the control unit 7C encrypts the telephone number Tell using the terminal specific identification number ID_{A} of the portable terminal MA stored in the internal memory 8 to generate telephone number generation information E-Tell. In step 22d, the control unit 7C adds the telephone number generation information E-Tell generated to a header of the encrypted content together with the encrypted content key and the bind key generation information. In step 3g, the control unit 7C stores the encrypted content added with the telephone number generation information E-Tell in the HDD 10. FIG. 25 is a diagram showing a constitution of the encrypted content stored in that way and additional information of the encrypted content.

Consequently, the downloaded content is stored in the HDD 10 of the portable terminal MA in a state in which the content is subjected to telephone number bind and added with the telephone number generation information E-Tell.

(2) Operation for Backing Up Content

For backup for the content stored in the HDD 10 of the portable terminal MA, the portable terminal MA is connected to the personal computer PC and, in this state, encrypted content to be backed up and additional information of the encrypted content are read out from the HDD 10 of the portable terminal MA and transferred to the personal computer PC. The encrypted content and the additional information of the encrypted content transferred are directly stored in a data memory.

(3) Operation for Restoring Backed-Up Content

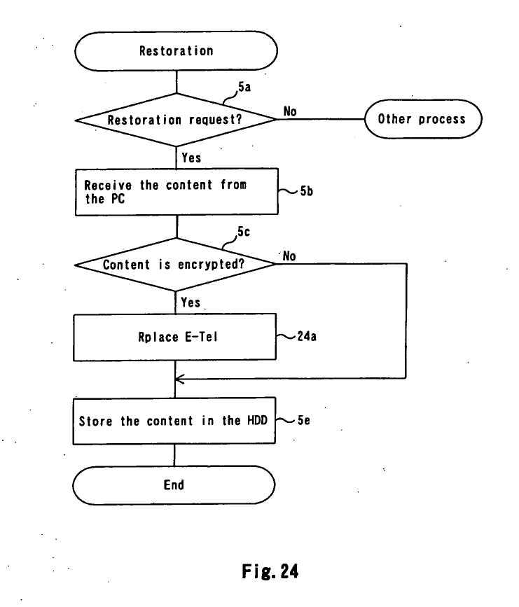

An operation for restoring encrypted content at the time when the portable terminal MA is changed to the portable terminal MB is performed as described below. FIG. 24 is a flowchart showing control procedures and control contents of the control unit 7C in the portable terminal MB at the restoration destination.

When a restoration request is received from the personal computer PC, as shown in FIG. 24, the control unit 7 of the portable terminal MB shifts from step 5a to step 5b. In step 5b, the control unit 7C receives content transferred from the personal computer PC and temporarily stores the content received in the internal memory 8.

Subsequently, in step 5c, the control unit 7C of the portable terminal MB judges whether the received content is encrypted content. As a result of the judgment, if the received content is encrypted content, the control unit 7C shifts to step 24a. In step 24a, the control unit 7C replaces the telephone number generation information E-Tell added to the encrypted content.

Processing for the replacement is performed as follows. The control unit 7C reads out the terminal specific identification number ID_{B} and the telephone number Tell of the portable terminal MB from the internal memory 8. The control unit 7C encrypts the telephone number Tell read out using the terminal specific identification number ID_{B} to create telephone number generation information E-Tell again. The control unit 7C replaces the telephone number generation information E-Tell added to the encrypted content with the telephone number generation information E-Tell created again. In step 5e, the control unit 7C stores the encrypted content with the telephone number generation information E-Tell replaced in the HDD 10.

Consequently, restored content is stored in the HDD 10 of the portable terminal MB after portable terminal change in a state in which the content is subjected to telephone number bind and added with the telephone number generation information E-Tell created again to be decodable in the portable terminal MB. An outline of the restoration operation is shown in FIG. 21.

(4) Operation for Reproducing Encrypted Content in the Portable Terminals MA and MB

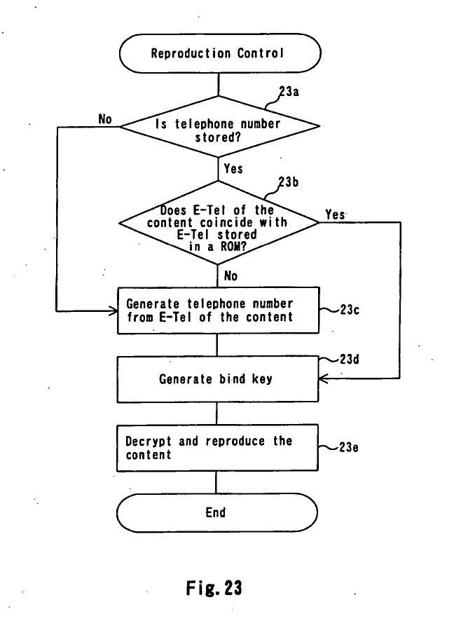

When a reproduction request for content is inputted, the control unit 7 executes reproduction control for the content as described below. FIG. 23 is a flowchart showing control procedures and control details of the reproduction control. First, in step 23a, the control unit 7C judges whether a telephone number is stored in the internal memory 8 of a portable terminal. As a result of the judgment, if a telephone number is stored, the control unit 7C judges that the portable terminal is in use.

Subsequently, in step 23b, the control unit 7C compares a value of telephone number generation information E-Tel added to the content to be reproduced and a value of telephone number generation information E-Tel that is generated on the basis of the telephone number and a terminal specific identification number stored in the internal memory 8. If both the values coincide with each other, the control unit 7C judges that the telephone number is not changed and shifts to step 23d. In step 23d, the control unit 7C generates a telephone number bind key. The telephone number bind key is generated on the basis of the telephone number and bind key generation information stored in the internal memory 8 as shown in FIG. 25. As the bind key generation information, for example, download time of the content, random numbers, and other confidential information stored in the portable terminal are used. As the other confidential information, for example, a carrier secret key given from a communication carrier is used.

When the telephone number bind key is generated, the control unit 7C shifts to step 23e. In step 23e, the control unit 7C decrypts the encrypted content key using the generated telephone number bind key and decrypts the encrypted content using the content key decrypted. If the content decrypted is music content, the control unit 7C causes the speaker 5 to amplify and output the music content. On the other hand, if the decrypted content is image content, the control unit 7C causes the display 14 to display the image content.

Consequently, it is possible to reproduce, not only in a portable terminal not changed but also in a portable terminal after portable terminal change, encrypted content on the basis of a telephone number if the portable terminal is in use.

On the other hand, it is assumed that, as a result of the judgment in step 23a, a telephone number is not stored in the internal memory 8. In this case, the control unit 7C judges that the portable terminal is a portable terminal in which a telephone number is erased according to the portable terminal change, that is, a portable terminal in which the internal memory 8 is changed to a blank ROM. Then, the control unit 7C shifts to step 23c and reproduces the telephone number before erasure on the basis of the telephone number generation information E-Tel added to the encrypted content to be reproduced and the terminal specific identification number of the portable terminal stored in the internal memory 8. In step 23d, the control unit 7C generates a telephone number bind key on the basis of the telephone number reproduced and the bind key generation information. In step 23e, the control unit 27C decrypts and reproduces the content as described above using the telephone number bind key generated.

Consequently, as shown in FIG. 21, it is also possible to decrypt and reproduce the encrypted content in the portable terminal in which the telephone number is erased according to the portable terminal change.

On the other hand, it is assumed that, as a result of the comparison of the telephone number generation information E-Tel in step 23b, both the values do not coincide with each other. In this case, the control unit 7C judges that the telephone number is changed and shifts to step 23c. In step 23c, the control unit 7C generates the telephone number before erasure on the basis of the telephone number generation information E-Tel added to the encrypted content to be reproduced and the terminal specific identification number of the portable terminal stored in the internal memory 8. In step 23d, the control unit 7C generates a telephone number bind key on the basis of the telephone number generated. In step 23e, the control unit 7C decrypts and reproduces the content as described above using the telephone number bind key generated.

Consequently, as shown in FIG. 21, it is also possible to decrypt and reproduce the content acquired and stored before the telephone number is changed.

As described above, in the fifth embodiment, when acquired content is encrypted and stored in a portable terminal, the content is encrypted according to the telephone number bind and telephone number generation information E-Tel obtained by encrypting the telephone number using a terminal specific identification number of the portable terminal is added to a header of the content. Therefore, regardless of the fact that the content is encrypted according to the telephone number bind, it is possible to decrypt and reproduce the encrypted content on the basis of the telephone number generation information E-Tel even after the telephone number in the internal memory 8 is erased according to portable terminal change or the like. When a telephone number is changed in an identical portable terminal, it is also possible to decrypt and reproduce encrypted content acquired at the time of an old telephone number on the basis of the telephone number generation information E-Tel.

### Sixth Embodiment

An information storing and reproducing system according to a sixth embodiment of the invention is obtained by further improving the information storing and reproducing system in the third embodiment. When encrypted content stored in the personal computer PC is restored in the portable terminal MB, processing for replacing the telephone number generation information E-Tell is performed in the personal computer PC.

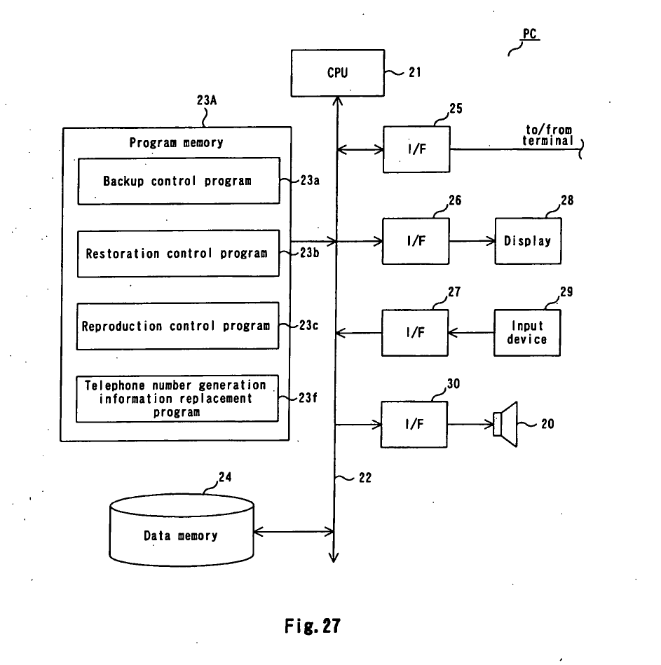

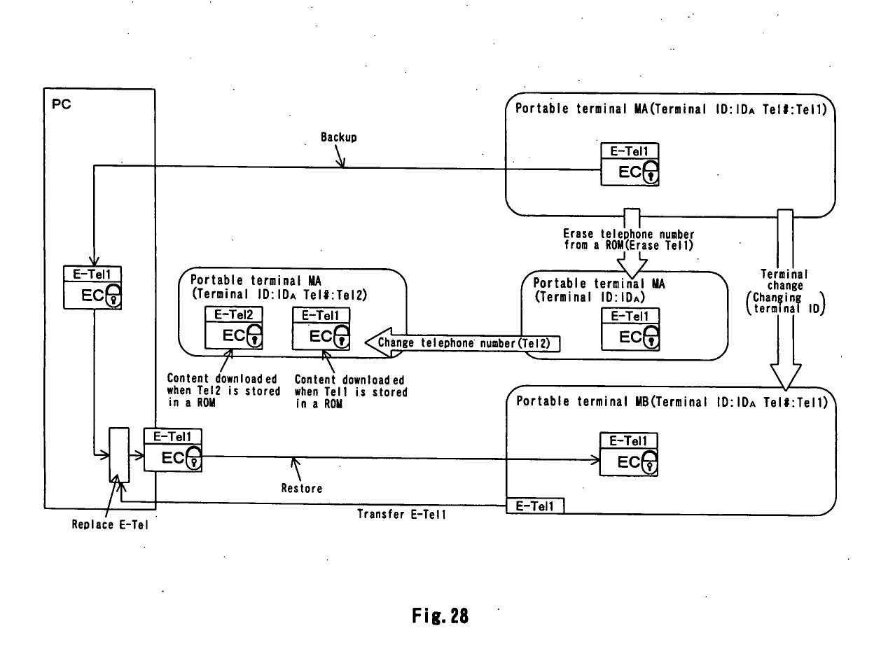

FIG. 27 is a block diagram showing a functional constitution of a personal computer PC used as an information backup apparatus in the information storing and reproducing system according to the sixth embodiment of the invention. In the figure, components identical with those in FIG. 6 are denoted by the identical reference numerals and signs. Detailed explanations of the components are omitted.

A telephone number generation information replacement program 23f is stored in a program memory 23C as a control program peculiar to this embodiment. When encrypted content added with the telephone number generation information E-Tell is restored in the portable terminal MB after portable terminal change from the personal computer PC, the telephone number generation information replacement program 23f performs processing for encrypting the telephone number Tell using the terminal specific identification number ID_{B} of the portable terminal MB to generate telephone number generation information E-Tell again and replacing the telephone number generation information E-Tell added to the encrypted content restored with the telephone number generation information E-Tell.

An operation for restoring content using the personal computer PC constituted as described above will be explained.

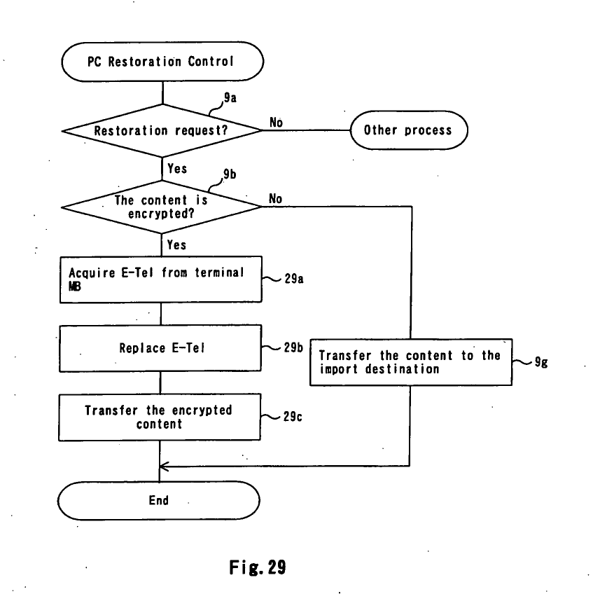

FIG. 28 is a system diagram used for explanation of the operation. FIG. 29 is a flowchart showing control procedures and control details of the personal computer PC. In FIG. 29, steps identical with those in FIG. 9 are denoted by the identical reference signs. Detailed explanations of the steps are omitted.

When the CPU 21 of the personal computer PC detects input of a restoration request in step 9a, the CPU 21 shifts to step 9b. In step 9b, the CPU 21 judges whether content to be restored is encrypted content. As a result of the judgment, if the content to be restored is encrypted content, the CPU 21 shifts to step 29a. In step 29a, as shown in FIG. 28, the CPU 21 sends a transmission request for telephone number generation information E-Tel to the portable terminal MB at the restoration destination and acquires the telephone number generation information E-Tel from the portable terminal MB as a response to the transmission request. The telephone number generation information E-Tel is generated by encrypting a telephone number stored in the internal memory 8 in the portable terminal MB using a terminal specific identification number of the portable terminal MB.

Subsequently, the CPU 21 shifts to step 29b. In step 29b, the CPU 21 replaces the telephone number generation information E-Tell added to the encrypted content to be restored with the telephone number generation information E-Tell acquired from the portable terminal MB. In step 29c, the CPU 21 transfers the encrypted content to be restored with the telephone number generation information E-Tell replaced to the portable terminal MB at the restoration destination.

Therefore, according to the sixth embodiment, as in the fifth embodiment, since the telephone number generation information E-Tel added to a header of the encrypted content is used, it is possible to decrypt and reproduce the encrypted content even after the telephone number in the internal memory 8 is erased according to the portable terminal change or the like. When a telephone number is changed in an identical portable terminal, it is also possible to decrypt and reproduce encrypted content acquired and stored at the time of an old telephone number.

Moreover, in this embodiment, processing for replacing the telephone number generation information E-Tel is performed in the personal computer PC, performance of a CPU of which is higher than that in the portable terminals MA and MB. Thus, it is possible to improve, as the information storing and reproducing system, processing efficiency and reduce processing burdens on the portable terminal MB.

### Other Embodiments

In the examples explained in the first to the fourth embodiments, content is acquired in the portable terminal MA and the content acquired is encrypted and stored in the portable terminal MA. However, it is also possible that content is acquired in the personal computer PC and the content acquired is imported to the portable terminal MA or the portable terminal MB after portable terminal change that replaces the portable terminal MA.

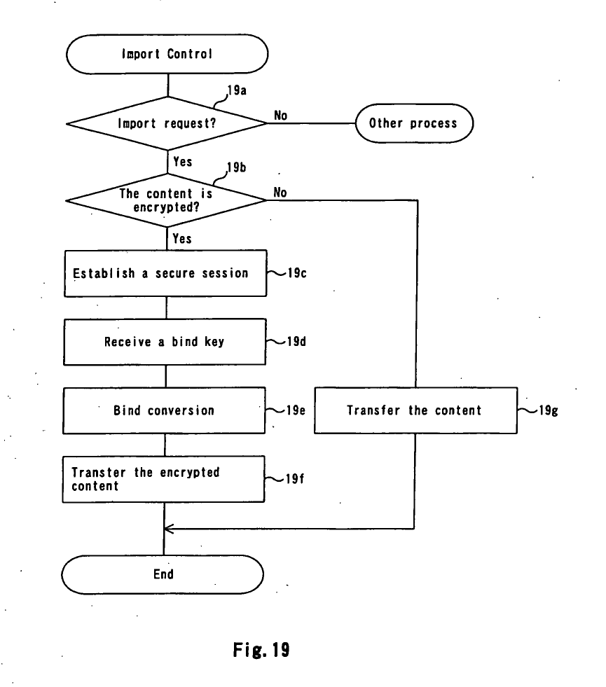

When this alternative is realized, for example, as shown in FIG. 19, in step 19a, the CPU 21 of the personal computer PC monitors input of an import request. When an import request is inputted in this state, in step 19b, the CPU 21 judges whether content to be imported is encrypted content. As a result of the judgment, if the content to be imported is encrypted content, in step 19c, the CPU 21 sets a secure session between the personal computer PC and the portable terminal MA or MB at the import destination. In step 19d, the CPU 21 acquires a bind key from the portable terminal MA or MB at the import destination. The bind key to be acquired is a terminal bind key in the information storing and reproducing systems in the first and the second embodiments and is a terminal bind key and a telephone number bind key in the information storing and reproducing systems in the third and the fourth embodiments.

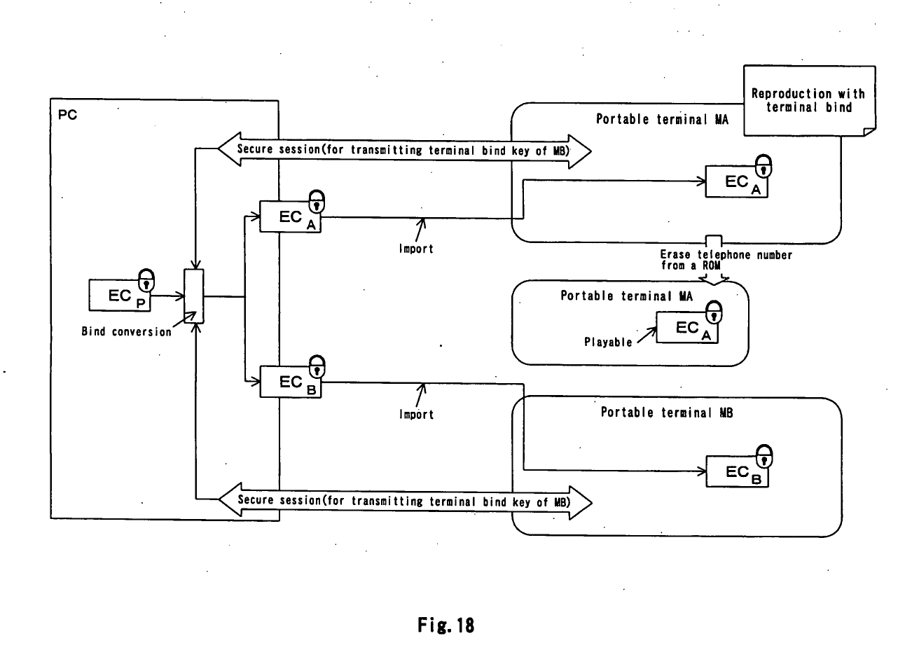

Subsequently, in step 19e, the CPU 21 applies bind conversion processing to the content to be imported. The bind conversion processing is processing for converting, as shown in FIG. 18, an encryption mode of the content to be imported from a state EC_{P} in which the content is encrypted by a PC bind key generated on the basis of a terminal specific identification number of the personal computer PC to a state EC_{A} or EC_{B} or EC_{AT} or EC_{BT} in which the content is encrypted by a terminal bind key or a telephone number bind key acquired from the portable terminal at the import destination. In step 19f, the CPU 21 transfers the encrypted content subjected to bind conversion to the portable terminal MA or MB at the import destination. When the content to be imported is not encrypted content, the CPU 21 shifts to step 19g and directly transfers the content to the portable terminal MA or MB at the import destination.

Therefore, in this embodiment, when encrypted content is imported, an encryption mode of the encrypted content is converted from PC bind to terminal bind corresponding to the portable terminal MA or MB at the import destination. Thus, even when a telephone number is erased in the portable terminal MA or MB, that is, when the internal memory 8 is changed to a blank ROM, it is possible to decrypt and reproduce the encrypted content.

It is also possible to perform import of encrypted content from the personal computer PC to the portable terminal MA or MB in the same manner in the sixth embodiment in which the telephone number generation information E-Tel is added to a header of encrypted content.

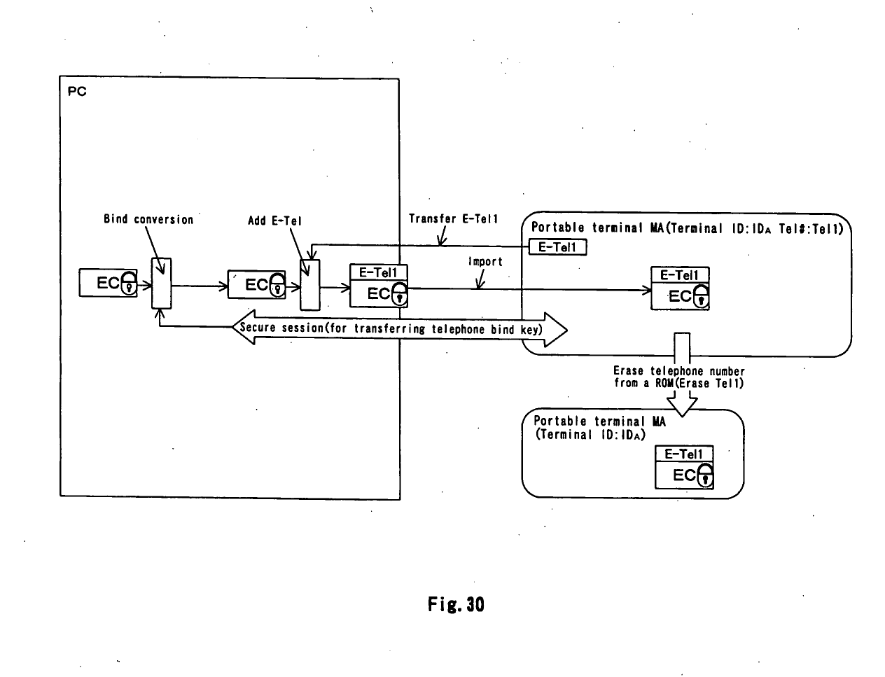

When encrypted content is imported to the portable terminal MA, as shown in FIG. 30, the personal computer PC converts an encryption mode of the encrypted content from the PC bind to telephone number bind based on a telephone number used by the portable terminal MA at the import destination. The conversion processing is possible by setting a secure session between the personal computer PC and the portable terminal MA at the import destination and acquiring a telephone number bind key from the portable terminal MA via the secure session.

Subsequently, the personal computer PC acquires telephone number generation information E-Tel from the portable terminal MA. The personal computer PC adds the telephone number generation information E-Tel acquired to a header of the encrypted content subjected to bind conversion. The personal computer PC transfers the encrypted content added with the telephone number generation information E-Tel to the portable terminal MA at the import destination.

Therefore, in this case, when a telephone number is erased in the portable terminal MA, that is, when the internal memory 8 is changed to a blank ROM, it is also possible to decrypt and reproduce the encrypted content by using the telephone number generation information E-Tel.

In the second and the fourth embodiments, a secure session is set between the personal computer PC and the portable terminal MA or MB and a bind key is transferred via the secure session. However, the invention is not limited to this. A content key encrypted by a bind key in the portable terminal MA or MB may be transferred. This makes it unnecessary to set a secure session.

As measures to be taken when a telephone number is erased, measures described below are conceivable. When a telephone number is erased from the internal memory 8 in a portable terminal, the telephone number is saved in another storage medium in the portable terminal prior to the erasure. When the telephone number is erased, that is, when the internal memory 8 is changed to a blank ROM, the telephone number saved in another storage medium is read out and a telephone number bind key is generated on the basis of the telephone number to decrypt and reproduce encrypted content.

Moreover, in the embodiments described above, a terminal bind key and a telephone number bind key are generated using common bind key generation information. However, it is also possible to generate a terminal bind key and a telephone number bind key using different bind key generation information. A terminal bind key and a telephone number bind key may be generated on the basis of a terminal specific identification number and a telephone number without using bind key generation information.

Furthermore, in the examples explained in the embodiments described above, a telephone number of a user of a portable terminal is used as user specific identification information. However, an e-mail address or a URL of the user may be used.

Besides, it is also possible to modify and implement types and constitutions of an information terminal and an information backup apparatus, means for acquiring content and a method of storing the content, processing procedures and processing details of backup and restoration, and the like in various ways without departing from the spirit of the invention.

The invention is not limited to the embodiments themselves. When the invention is carried out, it is possible to modify and embody elements of the invention without departing from the spirit of the invention. It is possible to form various inventions according to appropriate combinations of the plural elements disclosed in each of the embodiments. For example, some elements may be deleted from all the elements described in each of the embodiments. Moreover, the elements described in the different embodiments may be appropriately combined.

In the invention, in the first and the second information terminals, content is subjected to terminal bind and stored. When the content is backed up by the information backup apparatus, the content is converted into telephone number-bound content and stored. When the content stored is restored in an information terminal, the content is converted into terminal-bound content and stored.

Therefore, according to the invention, it is possible to provide an information storing and reproducing system and an information terminal and an information backup apparatus for the information storing and reproducing system that are capable of decrypting and reproducing, even if user specific identification information such as a telephone number is erased in the information terminal, encrypted content acquired before the erasure and performing backup and restoration of the encrypted content according to portable terminal change or the like.

What is claimed is:

1. A portable terminal connectable to a content server via a network, comprising:
an interface which is connectable to a back up terminal;
content acquiring means for acquiring a content from the content server;
first encrypting means for encrypting the content using content encryption key and outputting a encrypted content;
bind key generating means for generating a first bind key based upon the portable identification information and a second bind key based upon user identification information;
second encrypting means for encrypting the content encryption key based upon the first bind key and outputting a first encrypted content key;
a memory which stores the encrypted content and the first encrypted content key;
conversion means for converting the first encrypted content key into a second encrypted content key if back up request is received, wherein the conversion means decrypts the first encrypted content key using the first bind key and generates the content key, and encrypts the generated content key using the second bind key and generates the second encrypted content key; and
transfer means for transferring the encrypted content and the second encrypted content key to the back up terminal connected to the interface.

2. The portable terminal according to claim 1, wherein the user identification number is a telephone number.

3. The portable terminal according to claim 1, further comprising:
restoring means for restoring the encrypted content and the second encrypted content key from the back up terminal via the interface; and
second conversion means for converting the second encrypted content key into the third encrypted content key,
wherein the second conversion means decrypts the second encrypted content key using the second bind key and generates the content key, and encrypts the generated content key using the first bind key and generates the third encrypted content key, and the memory stores the encrypted content and the third encrypted content key.

4. The portable terminal according to claim 3, wherein the first encrypted content key coincides with the third encrypted content key.
